(19) United States
(12) Patent Application Publication
(10) Pub. No.: US 2025/0382449 A1
(43) Pub. Date: Dec. 18, 2025

(54) Thermoplastic Vulcanizate For Foaming Applications

(71) Applicant: Celanese International Corporation, Irving, TX (US)

(72) Inventors: Paul Nguyen, League City, TX (US); Jianya Cheng, Kingwood, TX (US); Edward J. Blok, Huffman, TX (US)

(21) Appl. No.: 19/235,659

(22) Filed: Jun. 12, 2025

Related U.S. Application Data
(60) Provisional application No. 63/661,117, filed on Jun. 18, 2024.

(51) Int. Cl. C08L 23/16; C08J 9/232

(52) U.S. Cl. CPC C08L 23/16; C08J 9/232; C08J 2203/22; C08J 2323/16; C08J 2423/12; C08L 2203/14; C08L 2203/30; C08L 2205/025; C08L 2205/035

(57) ABSTRACT

A thermoplastic vulcanizate composition is disclosed. The thermoplastic vulcanizate composition comprises: a thermoplastic vulcanizate comprising a thermoplastic resin, an at least partially cured rubber, and a propylene-based elastomer formed from at least three alpha-olefins. The thermoplastic vulcanizate composition exhibits a Shore A hardness of 45 or less in accordance with ASTM 2240-15(2021) (15 seconds; unaged). The thermoplastic vulcanizate composition may also comprise a foaming agent. A foamed thermoplastic vulcanizate composition is also disclosed formed from the aforementioned thermoplastic vulcanizate composition and a foaming agent.

### CROSS-REFERENCE TO RELATED APPLICATION

The present application claims filing benefit of U.S. Provisional Patent Application No. 63/661,117 having a filing date of Jun. 18, 2024, which is hereby incorporated by reference in its entirety.

### BACKGROUND OF THE INVENTION

In general, thermoplastic vulcanizates can be formed by dynamically vulcanizing a formulation including a thermoplastic resin and an elastomer. In this regard, the crosslinked elastomer may form an elastomeric phase with a thermoplastic phase of the thermoplastic resin. Accordingly, thermoplastic vulcanizates may exhibit both elastomeric and thermoplastic behavior. These thermoplastic vulcanizates can be utilized for a number of applications. In particular, additives may also be provided for various benefits and/or obtaining certain desired properties in a resulting thermoplastic vulcanizate. For example, certain additives, such as foaming agents, may be provided to reduce the density of the thermoplastic vulcanizate for various applications. However, it may be desired for the base thermoplastic vulcanizate to exhibit certain properties, such as mechanical properties, in order to provide a resulting foamed thermoplastic vulcanizate and article having the desired properties. Conventionally, certain additives may be utilized within the thermoplastic vulcanizate to obtain a desired specific gravity while also maintaining the mechanical properties. However, such additives may result in a thermoplastic vulcanizate having an increased hardness which may be undesirable for certain applications.

As such, a need currently exists for providing a foamable and foamed thermoplastic vulcanizate having desirable mechanical properties in conjunction with a relatively low hardness.

### SUMMARY OF THE INVENTION

In accordance with one embodiment of the present disclosure, a thermoplastic vulcanizate composition is disclosed. The thermoplastic vulcanizate composition comprises: a thermoplastic vulcanizate comprising a thermoplastic resin, an at least partially cured rubber, and a propylene-based elastomer formed from at least three alpha-olefins wherein the thermoplastic vulcanizate exhibits a Shore A hardness of 45 or less in accordance with ASTM 2240-15(2021) (15 seconds; unaged).

In accordance with one embodiment of the present disclosure, a thermoplastic vulcanizate composition is disclosed. The thermoplastic vulcanizate composition comprises: a thermoplastic vulcanizate comprising a thermoplastic resin, an at least partially cured rubber, and a propylene-based elastomer formed from at least three alpha-olefins wherein the thermoplastic vulcanizate exhibits a Shore A hardness of 45 or less in accordance with ASTM 2240-15(2021) (15 seconds; unaged) and a foaming agent.

In accordance with another embodiment of the present disclosure, a foamed thermoplastic vulcanizate composition is disclosed. The foamed thermoplastic vulcanizate composition is formed from a thermoplastic vulcanizate comprising a thermoplastic resin, an at least partially cured rubber, and a propylene-based elastomer formed from at least three alpha-olefins wherein the thermoplastic vulcanizate exhibits a Shore A hardness of 45 or less in accordance with ASTM 2240-15(2021) (15 seconds; unaged) and a foaming agent.

Other features and aspects of the present disclosure are set forth in greater detail below.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a thermoplastic vulcanizate composition comprising a thermoplastic vulcanizate. In particular, such thermoplastic vulcanizate composition and thermoplastic vulcanizate are foamable. In addition, such composition may also include a foaming agent to allow for a reduced density. In turn, the present disclosure is also directed to a foamed thermoplastic vulcanizate composition and foamed thermoplastic vulcanizate. Such foaming agent may allow for a thermoplastic vulcanizate composition and thermoplastic vulcanizate having a reduced density. Further, the thermoplastic vulcanizate composition and thermoplastic vulcanizate may also include a propylene-based elastomer, particularly one formed from at least three alpha-olefins.

The present inventors have discovered that the thermoplastic vulcanizate composition and thermoplastic vulcanizate disclosed herein may exhibit various advantages and characteristics suitable for particular applications. While having the desired mechanical properties, the thermoplastic vulcanizate composition and/or thermoplastic vulcanizate as described herein may be relatively soft. Accordingly, the thermoplastic vulcanizate composition and/or thermoplastic vulcanizate may have a relatively low hardness, in particular a Shore A hardness. In this regard, the Shore A hardness may be 45 or less, such as 43 or less, such as 40 or less, such as 38 or less, such as 35 or less, such as 33 or less, such as 30 or less, such as 28 or less, such as 25 or less, such as 23 or less. The Shore A hardness may be 15 or more, such as 18 or more, such as 20 or more, such as 22 or more, such as 25 or more, such as 27 or more. Such hardness may allow for the thermoplastic vulcanizate and/or composition and/or resulting molded part/article to provide the compliance necessary to effectively function for a desired application. In one embodiment, the aforementioned Shore A hardness may be for an unaged sample. The Shore A hardness may be determined in accordance with ASTM 2240-15(2021) (15 seconds).

In addition, the thermoplastic vulcanizate and/or corresponding composition may have a relatively low modulus. For instance, the 100% modulus (ASTM D412-16(2021), Die C, across flow), also referred to as the modulus at 100% elongation or M100, may be at least 0.3 MPa, such as from 0.1 to 10 MPa, such as from 0.1 to 8 MPa, such as from 0.3 to 1 MPa. For instance, the 100% modulus may be 0.1 MPa or more, such as 0.2 MPa or more, such as 0.3 MPa or more, such as 0.4 MPa or more, such as 0.5 MPa or more, such as 0.6 MPa or more, such as 0.7 MPa or more, such as 0.8 MPa or more, such as 0.9 MPa or more, such as 1 MPa or more, such as 1.1 MPa or more, such as 1.2 MPa or more, such as 1.3 MPa or more, such as 1.4 MPa or more, such as 1.5 MPa or more, such as 2 MPa or more, such as 2.5 MPa or more, such as 3 MPa or more, such as 4 MPa or more, such as 5 MPa or more. The 100% modulus may be 10 MPa or less, such as 8 MPa or less, such as 6 MPa or less, such as 5 MPa or less, such as 4.5 MPa or less, such as 4 MPa or less, such as 3.8 MPa or less, such as 3.5 MPa or less, such as 3.3 MPa or less, such as 3 MPa or less, such as 2.8 MPa or less, such as 2.5 MPa or less, such as 2.3 MPa or less, such as 2 MPa or less, such as 1.9 MPa or less, such as 1.8 MPa or less, such as 1.5 MPa or less, such as 1.3 MPa or less, such as 1.1 MPa or less, such as 1 MPa or less, such as 0.9 MPa or less, such as 0.8 MPa or less, such as 0.7 MPa or less, such as 0.6 MPa or less, such as 0.5 MPa or less, such as 0.4 MPa or less. In one embodiment, the aforementioned modulus at 100% elongation may be for an unaged sample.

Accordingly, the thermoplastic vulcanizate and/or corresponding composition may have a relatively low hardness and a relatively low modulus. In turn, such properties may allow for the thermoplastic vulcanizate and/or corresponding composition to be utilized for foaming applications.

Various embodiments of the present disclosure will now be described in more detail.

### I. Thermoplastic Vulcanizate and Composition

In general, the thermoplastic vulcanizate includes a thermoplastic resin, an at least partially cured rubber, and a propylene-based elastomer formed from at least three alpha-olefins. In this regard, the thermoplastic resin, the at least partially cured rubber, and the propylene-based elastomer may be presented within a thermoplastic vulcanizate composition as defined herein. Further, in order to form such a thermoplastic vulcanizate and resulting composition, a rubber may be provided within a formulation as defined herein to provide the at least partially cured rubber. The thermoplastic vulcanizate and/or corresponding formulation or composition as defined herein may also include at least one foaming agent. In addition, such thermoplastic vulcanizate and/or corresponding formulation or composition may also optionally include one or more additives as defined herein and/or generally known in the art.

### A. Thermoplastic Resin

As indicated above, the thermoplastic vulcanizate and corresponding formulation and composition contain a thermoplastic resin. In this regard, the thermoplastic vulcanizate may include one or more thermoplastic resins. In one embodiment, one thermoplastic resin may be utilized as the thermoplastic resin. In other embodiments, the thermoplastic resin may include a mixture of thermoplastic resins. For instance, more than one thermoplastic resin, such as two or three thermoplastic resins, may be utilized.

Furthermore, the respective thermoplastic resin may be a homopolymer or a copolymer. In one embodiment, the respective thermoplastic resin may be a homopolymer. In another embodiment, the respective thermoplastic resin may be a copolymer.

In general, any thermoplastic resin suitable for use in the manufacture of a thermoplastic vulcanizate can be employed as the thermoplastic resin. For instance, the thermoplastic resin may include a polyolefin, a polyimide, a polyester, a polyamide, poly(phenylene ether), a polycarbonate, a styrene-acrylonitrile copolymer, polyethylene terephthalate, polybutylene terephthalate, polystyrene, polystyrene derivatives, polyphenylene oxide, polyoxymethylene, fluorine-containing thermoplastic resins, or a mixture thereof.

In one embodiment, the thermoplastic resin may include at least a polyolefin. The polyolefin can be formed by polymerizing one or more alpha-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another alpha-olefin such as 1-butene, 1-hexene, 1-octene, 2-methyl-1-propene, 3-methyl-1-pentene, 4-methyl-1-pentene, 5-methyl-1-hexene or mixtures thereof may be also utilized in accordance with the present disclosure.

In one embodiment, the thermoplastic resin, such as the polyolefin, may be a copolymer. In one embodiment, when the primary monomer is ethylene, the comonomer may be propylene and/or a C₄-C₈ alpha-olefin monomer. In one embodiment, the comonomer may be propylene. In another embodiment, the comonomer may be a C₄-C₈ alpha-olefin monomer, such as 1-butene and/or 1-hexene. In a further embodiment, the comonomer may be propylene and at least one C₄-C₈ alpha-olefin monomer. When the primary monomer is propylene, the comonomer may be ethylene and/or a C₄-C₈ alpha-olefin monomer. In one embodiment, the comonomer may be ethylene. In another embodiment, the comonomer may be a C₄-C₈ alpha-olefin monomer. In a further embodiment, the comonomer may be ethylene and at least one C₄-C₈ alpha-olefin monomer, such as 1-butene and/or 1-hexene.

Other suitable polyolefin copolymers may include copolymers of olefins with styrene such as styrene-ethylene copolymer or polymers of olefins with α,β-unsaturated acids, α,β-unsaturated esters such as polyethylene-acrylate copolymers. Non-olefin thermoplastic resins may include polymers and copolymers of styrene, α,β-unsaturated acids, α,β-unsaturated esters, and mixtures thereof. For example, polystyrene, polyacrylate, and polymethacrylate may be used.

When the thermoplastic resin includes a polyolefin copolymer formed of ethylene or propylene as the primary monomer, the corresponding comonomer(s) may be present in an amount of 0.1 wt. % or more, such as 0.2 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more based on the weight of the copolymer. The comonomer(s) may be present in an amount of 40 wt. % or less, such as 30 wt. % or less, such as 25 wt. % or less, such as 20 wt. % or less, such as 15 wt. % or less, such as 10 wt. % or less, such as 8 wt. % or less, such as 7 wt. % or less, such as 6 wt. % or less, such as 5 wt. % or less based on the weight of the copolymer. Similarly, the corresponding comonomer(s) may be present in an amount of 0.1 mol. % or more, such as 0.2 mol. % or more, such as 0.5 mol. % or more, such as 1 mol. % or more, such as 2 mol. % or more, such as 5 mol. % or more, such as 10 mol. % or more, such as 15 mol. % or more, such as 20 mol. % or more based on the total number of moles in the copolymer. The comonomer(s) may be present in an amount of 40 mol. % or less, such as 30 mol. % or less, such as 25 mol. % or less, such as 20 mol. % or less, such as 15 mol. % or less, such as 10 mol. % or less, such as 8 mol. % or less, such as 7 mol. % or less, such as 6 mol. % or less, such as 5 mol. % or less based on the total number of moles in the copolymer.

In one embodiment, the polyolefin may be an ethylene polymer, a propylene polymer, or a mixture thereof. In this regard, in one embodiment, the polyolefin may be an ethylene polymer. In another embodiment, the polyolefin may be a propylene polymer. In a further embodiment, the polyolefin may be a mixture of an ethylene polymer and a propylene polymer.

The ethylene polymer may be a polyethylene homopolymer in one embodiment. In another embodiment, the ethylene polymer may be an ethylene copolymer.

In addition to the above, in one embodiment, the ethylene polymer may have a particular density. For instance, the density may be from about 0.80 g/cm³ to about 1 g/cm³, such as from about 0.84 g/cm³ to about 0.99 g/cm³, such as from about 0.84 g/cm³ to about 0.94 g/cm³, such as from about 0.85 g/cm³ to about 0.94 g/cm³, such as from about 0.91 g/cm³ to about 0.94 g/cm³. In this regard, the ethylene polymer may be a linear low-density polyethylene (LLDPE), a low density polyethylene (LDPE), a medium density polyethylene (MDPE), a high density polyethylene (HDPE), or a mixture thereof. Such polyethylenes may have a particular density as determined in accordance with ASTM D792. For instance, a linear low-density polyethylene (LLDPE) may have a density in the range of from about 0.91 g/cm³ to about 0.94 g/cm³. Meanwhile, a low-density polyethylene (LDPE) may have a density in the range of from about 0.91 g/cm³ to about 0.925 g/cm³. A medium density polyethylene (MDPE) may have a density in the range of from about 0.926 g/cm³ to about 0.94 g/cm³. Also, a high-density polyethylene (HDPE) may have density in the range of from about 0.941 g/cm³ to about 0.965 g/cm³. In one embodiment, the ethylene polymer may be a low-density polyethylene. In another embodiment, the ethylene polymer may be a linear low-density polyethylene. In a further embodiment, the ethylene polymer may be a medium density polyethylene.

The propylene polymer may be a polypropylene homopolymer in one embodiment. In another embodiment, the propylene polymer may be a propylene copolymer. Furthermore, the propylene polymer may be isotactic or syndiotactic polypropylene. For instance, the propylene polymer may be isotactic polypropylene in one embodiment. In another embodiment, the propylene polymer may be syndiotactic polypropylene. In one embodiment, the propylene copolymer may be a random copolymer.

These homopolymers and copolymers may be synthesized using any polymerization technique known in the art such as, but not limited to, the Phillips catalyzed reactions, conventional Ziegler-Natta type polymerizations, and metallocene catalysis including, but not limited to, metallocene-alumoxane and metallocene-ionic activator catalysis. Suitable catalyst systems thus include chiral metallocene catalyst systems, see, e.g., U.S. Pat. No. 5,441,920, and transition metal-centered, heteroaryl ligand catalyst systems, see, e.g., U.S. Pat. No. 6,960,635.

In general, the thermoplastic resin can include a solid, generally high molecular weight polymeric material. The thermoplastic resin may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mw may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. Furthermore, the thermoplastic resin may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mn may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. In general, the molecular weight may be characterized by GPC (gel permeation chromatography) using polystyrene standards.

In one embodiment, the thermoplastic resin may not be a branched thermoplastic resin. In particular, the thermoplastic resin may not be a long-chain branched thermoplastic resin. For instance, a long-chain branched thermoplastic resin may be as defined in U.S. Pat. Nos. 6,433,090 and 6,503,985.

The thermoplastic resin may be a crystalline polymer in one embodiment or a semi-crystalline polymer in another embodiment. For instance, the crystallinity may be at least 25%, such as at least 35%, such as at least 45%, such as at least 55%, such as at least 65%, such as at least 70% by weight. The crystallinity may be determined by differential scanning calorimetry. For instance, crystallinity may be determined by dividing the heat of fusion of a sample by the heat of fusion of a 100% crystalline polymer.

The thermoplastic resin may also have a particular glass transition temperature (“Tg”). For instance, the glass transition temperature may be relatively high. In this regard, the Tg may be about −120° C. or more, such as −110° C. or more, such as −100° C. or more, such as −90° C. or more, such as −70° C. or more, such as −50° C. or more, such as −30° C. or more, such as −25° C. or more, such as −20° C. or more, such as −15° C. or more, such as −10° C. or more, such as −5° C. or more, such as 0° C. or more, such as 5° C. or more, such as 10° C. or more, such as 20° C. or more, such as 30° C. or more, such as 50° C. or more, such as 80° C. or more, such as 100° C. or more, such as 120° C. or more, such as 140° C. or more, such as 160° C. or more, such as 180° C. or more, such as 200° C. or more. The Tg may be about 300° C. or less, such as 260° C. or less, such as 220° C. or less, such as 180° C. or less, such as 140° C. or less, such as 100° C. or less, such as 80° C. or less, such as 60° C. or less, such as 40° C. or less, such as 30° C. or less, such as 20° C. or less, such as 10° C. or less, such as 5° C. or less, such as 0° C. or less, such as −5° C. or less.

In addition, the thermoplastic resin may have a particular melt temperature (“Tm”). For instance, the melt temperature of the thermoplastic resin may be relatively high. Furthermore, the melt temperature of the thermoplastic resin may be lower than the decomposition temperature of the rubber in the thermoplastic vulcanizate, such decomposition temperature generally characterized as when the molecular bonds begin to break or scission such that the molecular weight of the rubber begins to decrease. In this regard, the Tm may be about 100° C. or more, such as 120° C. or more, such as 130° C. or more, such as 140° C. or more, such as 150° C. or more, such as 160° C. or more, such as 170° C. or more, such as 180° C. or more, such as 190° C. or more, such as 200° C. or more, such as 240° C. or more, such as 280° C. or more. The Tm may be about 400° C. or less, such as 360° C. or less, such as 320° C. or less, such as 300° C. or less, such as 280° C. or less, such as 250° C. or less, such as 220° C. or less, such as 200° C. or less, such as 180° C. or less, such as 160° C. or less.

The thermoplastic resin may also be characterized as having a particular heat of fusion. For instance, the heat of fusion may be about 0.1 J/g or more, such as about 1 J/g or more, such as about 2 J/g or more, such as about 5 J/g or more, such as about 10 J/g or more, such as about 10 J/g or more, such as about 30 J/g or more, such as 40 J/g or more, such as 50 J/g or more, such as 60 J/g or more, such as 70 J/g or more, such as 100 J/g or more, such as 120 J/g or more, such as 140 J/g or more, such as 160 J/g or more, such as 180 J/g or more, such as 200 J/g or more. The heat of fusion may be about 300 J/g or less, such as about 260 J/g or less, such as about 240 J/g or less, such as about 200 J/g or less, such as about 180 J/g or less, such as about 150 J/g or less, such as about 120 J/g or less, such as about 100 J/g or less, such as about 80 J/g or less, such as about 60 J/g or less, such as about 50 J/g or less, such as about 40 J/g or less, such as about 30 J/g or less, such as about 20 J/g or less.

The thermoplastic resin may have a melt flow rate of up to 400 g/10 min. In general, the thermoplastic resin may have a melt flow rate of 30 g/10 min or less, such as 25 g/10 min or less, such as 20 g/10 min or less, such as 15 g/10 min or less, such as 10 g/10 min or less, such as 8 g/10 min or less, such as 6 g/10 min or less, such as 5 g/10 min or less, such as 4 g/10 min or less, such as 3 g/10 min or less, such as 2 g/10 min or less, such as 1 g/10 min or less, such as 0.8 g/10 min or less. In general, the melt flow rate may be 0.1 g/10 min or more, such as 0.2 g/10 min or more, such as 0.3 g/10 min or more, such as 0.4 g/10 min or more, such as 0.5 g/10 min or more, such as 1 g/10 min or more, such as 1.5 g/10 min or more, such as 2 g/10 min or more, such as 2.5 g/10 min or more, such as 3 g/10 min or more. Melt flow rate is a measure of how easily a polymer flows under standard pressure and is measured by using ASTM D-1238-10 at 230° C. and 2.16 kg load.

The thermoplastic resin may be present in an amount of about 3 phr or more, such as about 5 phr or more, such as about 8 phr or more, such as about 10 phr or more, such as about 13 phr or more, such as about 15 phr or more, such as about 20 phr or more, such as about 25 phr or more, such as about 30 phr or more, such as about 40 phr or more. The thermoplastic resin may be present in an amount of about 70 phr or less, such as about 60 phr or less, such as about 50 phr or less, such as about 40 phr or less, such as about 30 phr or less, such as about 25 phr or less, such as about 20 phr or less, such as about 18 phr or less, such as about 15 phr or less, such as about 13 phr or less, such as about 10 phr or less, such as about 8 phr or less, such as about 5 phr or less.

The thermoplastic vulcanizate and corresponding formulation and composition may generally comprise about 0.5 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 5 wt. % or more, such as about 8 wt. % or more, such as about 10 wt. % or more of the thermoplastic resin. The thermoplastic vulcanizate and corresponding formulation and composition may comprise about 25 wt. % or less, such as about 20 wt. % or less, such as about 15 wt. % or less, such as about 10 wt. % or less, such as about 8 wt. % or less, such as about 6 wt. % or less, such as about 5 wt. % or less, such as about 4.5 wt. % or less, such as about 4 wt. % or less, such as about 3.5 wt. % or less, such as about 3 wt. % or less, such as about 2.5 wt. % or less of the thermoplastic resin. In one embodiment, such aforementioned weight percentages may apply to a respective thermoplastic resin. In another embodiment, such aforementioned weight percentages may apply to all thermoplastic resins utilized. In one embodiment, such aforementioned weight percentages may be based on the combined weight of the thermoplastic resin and the rubber combined within the thermoplastic vulcanizate and/or corresponding formulation and composition. In one embodiment, such aforementioned weight percentages may be based on the combined weight of the thermoplastic resin, the rubber, and the propylene-based elastomer combined within the thermoplastic vulcanizate and/or corresponding formulation and composition.

When the thermoplastic vulcanizate includes a first thermoplastic resin and a second thermoplastic resin, they may be present in certain amounts. For instance, the thermoplastic resin may generally comprise about 5 wt. % or more, such as about 8 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more, such as about 70 wt. % or more, such as about 80 wt. % or more, such as about 90 wt. % or more of the first thermoplastic resin. The thermoplastic resin may comprise about 98 wt. % or less, such as about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 15 wt. % or less, such as about 10 wt. % or less of the first thermoplastic resin.

The thermoplastic resin may generally comprise about 5 wt. % or more, such as about 8 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more, such as about 70 wt. % or more, such as about 80 wt. % or more, such as about 90 wt. % or more of the second thermoplastic resin. The thermoplastic resin may comprise about 98 wt. % or less, such as about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 15 wt. % or less, such as about 10 wt. % or less of the second thermoplastic resin.

### B. Rubber

In general, the thermoplastic vulcanizate contains an at least partially cured rubber. Due to the dynamic vulcanization, the thermoplastic vulcanizate contains an at least partially cured rubber. In general, any rubber suitable for use in the manufacture of TPVs can be utilized in accordance with the present disclosure. In one embodiment, one rubber may be utilized. In other embodiments, a mixture of rubbers may be utilized. For instance, more than one rubber, such as two or three rubbers, may be utilized in the thermoplastic vulcanizate and corresponding formulation and composition.

Any rubber or mixture thereof that is capable of being vulcanized (that is crosslinked or cured) can be used as the rubber (also referred to herein sometimes as the elastomer). Reference to a rubber or elastomer may include mixtures of more than one. Useful rubbers typically contain a degree of unsaturation in their polymeric main chain. Some non-limiting examples of these rubbers include polyolefin copolymer elastomers, butyl rubber, natural rubber, styrene-butadiene copolymer rubber (e.g., styrene/ethylene-butadiene/styrene), butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlorohydrin terpolymer rubber, and polychloroprene.

Vulcanizable rubbers includes polyolefin copolymer elastomers. These copolymers are made from one or more of ethylene and higher alpha-olefins, which may include, but are not limited to propylene, 1-butene, 1-hexene, 4-methyl-1 pentene, 1-octene, 1-decene, or combinations thereof, and may include one or more copolymerizable, multiply unsaturated comonomer, such as diolefins, or diene monomers. The alpha-olefins can be propylene, 1-hexene, 1-octene, or combinations thereof. These rubbers may lack substantial crystallinity and can be suitably amorphous copolymers.

The diene monomers may include, but are not limited to, 5-ethylidene-2-norbornene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; 5-vinyl-2-norbornene, divinyl benzene, and the like, or a combination thereof. The diene monomers can be 5-ethylidene-2-norbornene and/or 5-vinyl-2-norbornene. If the copolymer is prepared from ethylene, alpha-olefin, and diene monomers, the copolymer may be referred to as a terpolymer (EPDM rubber), or a tetrapolymer in the event that multiple alpha-olefins or dienes, or both, are used (EAODM rubber).

Rubbers that are polyolefin copolymer elastomers can contain, unless specified otherwise herein, from about 15 to about 90 mole percent ethylene units deriving from ethylene monomer, from about 40 to about 85 mole percent, or from about 50 to about 80 mole percent ethylene units. The copolymer may contain from about 10 to about 85 mole percent, or from about 15 to about 50 mole percent, or from about 20 to about 40 mole percent, alpha-olefin units deriving from alpha-olefin monomers. The foregoing mole percentages are based upon the total moles of the mer units of the polymer. Where the copolymer contains diene units, the copolymers may contain from 0.1 to about 14 weight percent, from about 0.2 to about 13 weight percent, or from about 1 to about 12 weight percent units deriving from diene monomer. The weight percent diene units deriving from diene may be determined according to ASTM D-6047. In some occurrences, the copolymers contain less than 5.5 weight percent, such as less than 5.0 weight percent, such as less than 4.5 weight percent, such as less than 4.0 weight percent units deriving from diene monomer. In yet other cases, the copolymers contain greater than 6.0 weight percent, such as greater than 6.2 weight percent, such as greater than 6.5 weight percent, such as greater than 7.0 weight percent units, such as greater than 8.0 weight percent deriving from diene monomer.

The polyolefin copolymer elastomer may be obtained using polymerization techniques known in the art such as traditional solution or slurry polymerization processes. For instance, the catalyst employed to polymerize the ethylene, alpha-olefin, and diene monomers into elastomeric copolymers can include both traditional Ziegler-Natta type catalyst systems, especially those including titanium and vanadium compounds, as well as metallocene catalysts for Group 3-6 (titanium, zirconium and hafnium) metallocene catalysts, particularly the bridged mono- or biscyclopentadienyl metallocene catalysts. Other catalyst systems such as Brookhart catalyst systems may also be employed.

In one embodiment, the rubber may include a butyl rubber. For instance, the butyl rubber includes copolymers and terpolymers of isobutylene and at least one other comonomer. Useful comonomers include isoprene, divinyl aromatic monomers, alkyl substituted vinyl aromatic monomers, and mixtures thereof. Exemplary divinyl aromatic monomers include vinyl styrene. Exemplary alkyl substituted vinyl aromatic monomers include a-methyl styrene and paramethyl styrene. These copolymers and terpolymers may also be halogenated such as in the case of chlorinated and brominated butyl rubber. In one or more embodiments, these halogenated polymers may derive from monomers such as parabromomethylstyrene.

In one or more embodiments, the butyl rubber includes copolymers of isobutylene and isoprene, copolymers of isobutylene and paramethyl styrene, terpolymers of isobutylene, isoprene, and divinyl styrene, branched butyl rubber, and brominated copolymers of isobutene and paramethylstyrene (yielding copolymers with parabromomethylstyrenyl mer units). These copolymers and terpolymers may be halogenated. Furthermore, butyl rubbers may be prepared by polymerization, using techniques known in the art such as at a low temperature in the presence of a Friedel-Crafts catalyst.

In one embodiment, where the butyl rubber includes the isobutylene-isoprene copolymer, the copolymer may include from about 0.5 to about 30, or from about 0.8 to about 5, percent by weight isoprene based on the entire weight of the copolymer with the remainder being isobutylene.

In another embodiment, where the butyl rubber includes isobutylene-paramethyl styrene copolymer, the copolymer may include from about 0.5 to about 25, and from about 2 to about 20, percent by weight paramethyl styrene based on the entire weight of the copolymer with the remainder being isobutylene. In one embodiment, isobutylene-paramethyl styrene copolymers can be halogenated, such as with bromine, and these halogenated copolymers can contain from about 0 to about 10 percent by weight, or from about 0.3 to about 7 percent by weight halogenation.

In other embodiments, where the butyl rubber includes isobutylene-isoprene-divinyl styrene, the terpolymer may include from about 95 to about 99, or from about 96 to about 98.5, percent by weight isobutylene, and from about 0.5 to about 5, or from about 0.8 to about 2.5, percent by weight isoprene based on the entire weight of the terpolymer, with the balance being divinyl styrene.

In the case of halogenated butyl rubbers, the butyl rubber may include from about 0.1 to about 10, or from about 0.3 to about 7, or from about 0.5 to about 3 percent by weight halogen based upon the entire weight of the copolymer or terpolymer.

In one or more embodiments, the glass transition temperature (Tg) of the butyl rubber can be less than about −55° C., or less than about −58° C., or less than about −60° C., or less than about −63° C. Also, the Mooney viscosity (ML₁₊₈@125° C.) of the butyl rubber can be from about 25 to about 75, or from about 30 to about 60, or from about 40 to about 55.

In general, the rubber, in particular the polyolefin copolymer elastomer, may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mw may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. Furthermore, the rubber, in particular the polyolefin copolymer elastomer, may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mn may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. In general, the molecular weight may be characterized by GPC (gel permeation chromatography) using polystyrene standards.

The thermoplastic vulcanizate and corresponding formulation and composition may generally comprise about 2 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 40 wt. % or more, such as about 50 wt. % or more, such as about 60 wt. % or more, such as about 70 wt. % or more, such as about 80 wt. % or more, such as about 85 wt. % or more, such as about 90 wt. % or more of the rubber or at least partially cured rubber, depending on whether referring to the thermoplastic vulcanizate and corresponding formulation and composition. The thermoplastic vulcanizate and/or formulation may comprise about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 35 wt. % or less, such as about 30 wt. % or less, such as about 25 wt. % or less, such as about 20 wt. % or less, such as about 15 wt. % or less of the rubber or at least partially cured rubber, depending on whether referring to the thermoplastic vulcanizate or corresponding formulation or composition. In one embodiment, such aforementioned weight percentages may apply to a respective rubber. In another embodiment, such aforementioned weight percentages may apply to all rubbers utilized. In one embodiment, such aforementioned weight percentages may be based on the combined weight of the thermoplastic resin and the rubber or at least partially cured rubber combined in the thermoplastic vulcanizate and/or corresponding formulation or composition. In one embodiment, such aforementioned weight percentages may be based on the combined weight of the thermoplastic resin, the rubber, and the propylene-based elastomer combined within the thermoplastic vulcanizate and/or corresponding formulation and composition.

### C. Propylene-Based Elastomer

As indicated above, the thermoplastic vulcanizate and corresponding formulation and composition may contain a propylene-based elastomer, particularly one formed from at least three alpha-olefins. In general, any propylene-based elastomer suitable for use can be utilized in accordance with the present disclosure. In one embodiment, one propylene-based elastomer may be utilized. In other embodiments, the propylene-based elastomer may include a mixture of propylene-based elastomers. For instance, more than one propylene-based elastomer, such as two or three propylene-based elastomers, may be utilized in the thermoplastic vulcanizate and corresponding formulation and/or composition. Such additional propylene-based elastomers may be formed from at least two alpha-olefins or may also be formed from at least three alpha-olefins.

As indicated herein, at least one propylene-based elastomer is formed from at least three alpha-olefins. In one embodiment, the propylene-based elastomer may be formed from at least four alpha-olefins. However, as indicated herein, to the extent the formulation and resulting thermoplastic vulcanizate include more than one propylene-based elastomer, any such additional or secondary propylene-based elastomer may be formed from at least two alpha-olefins.

In general, the propylene-based elastomer is a includes propylene-derived units. In addition, the propylene-based elastomer may include units derived from ethylene and/or one or more of a C₄-C₂₀ alpha-olefin, such as one or more of a C₄-C₁₀ alpha-olefin, such as one or more of a C₄-C₈ alpha-olefin, such as one or more of a C₄-C₆ alpha-olefin. These alpha-olefins may include, but are not limited to, 1-butene, 1-hexene, 1-octene, 2-methyl-1-propene, 3-methyl-1-pentene, 4-methyl-1-pentene, 5-methyl-1-hexene, and mixtures thereof. Terpolymers of propylene, ethylene, and another alpha-olefin such as 1-butene, 1-hexene, 1-octene, 2-methyl-1-propene, 3-methyl-1-pentene, 4-methyl-1-pentene, 5-methyl-1-hexene or mixtures thereof may be utilized in accordance with the present disclosure. In one embodiment, the additional alpha-olefin may be 1-butene.

In one embodiment, the propylene-based elastomer is a copolymer of propylene-derived units, units derived from ethylene, and units derived from a C₄-C₂₀ alpha-olefin, such as a C₄-C₁₀ alpha-olefin, such as a C₄-C₈ alpha-olefin, such as a C₄-C₆ alpha-olefin. In one embodiment, a secondary propylene-based elastomer is a copolymer of propylene-derived units and units derived from ethylene.

The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer may be generally devoid of any substantial intermolecular heterogeneity in tacticity and comonomer composition and may be generally devoid of any substantial heterogeneity in intramolecular composition distribution.

The propylene-based elastomer may contain at least about 60 wt. %, such as at least 62 wt. %, such as at least 65 wt. %, such as at least 67 wt. %, such as at least 70 wt. %, such as at least 72 wt. %, such as at least 75 wt. %, such as at least 78 wt. %, such as at least 80 wt. %, such as at least 83 wt. %, such as at least 85 wt. % of propylene-derived units. The propylene-based elastomer may contain 88 wt. % or less, such as 86 wt. % or less, such as 84 wt. % or less, such as 82 wt. % or less, such as 80 wt. % or less, such as 77 wt. % or less, such as 75 wt. % or less, such as 73 wt. % or less, such as 70 wt. % or less, such as 68 wt. % or less, such as 65 wt. % or less of propylene-derived units.

The propylene-based elastomer may contain at least about 60 mol %, such as at least 62 mol %, such as at least 65 mol %, such as at least 67 mol %, such as at least 70 mol %, such as at least 72 mol %, such as at least 75 mol %, such as at least 78 mol %, such as at least 80 mol % of propylene-derived units. The propylene-based elastomer may contain 84 mol % or less, such as 82 mol % or less, such as 80 mol % or less, such as 77 mol % or less, such as 75 mol % or less, such as 73 mol % or less, such as 70 mol % or less, such as 68 mol % or less, such as 65 mol % or less, such as 63 mol % or less of propylene-derived units.

The propylene-based elastomer may contain at least 12 wt. %, such as at least 14 wt. %, such as at least 16 wt. %, such as at least 18 wt. %, such as at least 20 wt. %, such as at least 22 wt. %, such as at least 25 wt. %, such as at least 27 wt. %, such as at least 30 wt. %, such as at least 32 wt. % of units derived from ethylene and/or another alpha olefin as described herein. The propylene-based elastomer may contain 38 wt. % or less, such as 35 wt. % or less, such as 33 wt. % or less, such as 30 wt. % or less, such as 28 wt. % or less, such as 25 wt. % or less, such as 23 wt. % or less, such as 20 wt. % or less, such as 18 wt. % or less of units derived from ethylene and/or another alpha olefin as described herein.

The propylene-based elastomer may contain at least 16 mol %, such as at least 18 mol %, such as at least 20 mol %, such as at least 22 mol %, such as at least 25 mol %, such as at least 27 mol %, such as at least 30 mol %, such as at least 32 mol %, such as at least 35 mol %, such as at least 37 mol % of units derived from ethylene and/or another alpha olefin as described herein. The propylene-based elastomer may contain 40 mol % or less, such as 38 mol % or less, such as 35 mol % or less, such as 33 mol % or less, such as 30 mol % or less, such as 28 mol % or less, such as 25 mol % or less, such as 23 mol % or less, such as 20 mol % or less of units derived from ethylene and/or another alpha olefin as described herein.

The propylene-based elastomer may contain at least 12 wt. %, such as at least 14 wt. %, such as at least 16 wt. %, such as at least 18 wt. %, such as at least 20 wt. %, such as at least 22 wt. %, such as at least 25 wt. %, such as at least 27 wt. %, such as at least 30 wt. %, such as at least 32 wt. % of units derived from ethylene. The propylene-based elastomer may contain 38 wt. % or less, such as 35 wt. % or less, such as 33 wt. % or less, such as 30 wt. % or less, such as 28 wt. % or less, such as 25 wt. % or less, such as 23 wt. % or less, such as 20 wt. % or less, such as 18 wt. % or less of units derived from ethylene.

The propylene-based elastomer may contain at least 16 mol %, such as at least 18 mol %, such as at least 20 mol %, such as at least 22 mol %, such as at least 25 mol %, such as at least 27 mol %, such as at least 30 mol %, such as at least 32 mol %, such as at least 35 mol %, such as at least 37 mol % of units derived from ethylene. The propylene-based elastomer may contain 40 mol % or less, such as 38 mol % or less, such as 35 mol % or less, such as 33 mol % or less, such as 30 mol % or less, such as 28 mol % or less, such as 25 mol % or less, such as 23 mol % or less, such as 20 mol % or less of units derived from ethylene.

The propylene-based elastomer may contain at least 1 wt. %, such as at least 3 wt. %, such as at least 5 wt. %, such as at least 7 wt. %, such as at least 10 wt. %, such as at least 12 wt. %, such as at least 14 wt. %, such as at least 16 wt. %, such as at least 18 wt. %, such as at least 20 wt. %, such as at least 22 wt. %, such as at least 25 wt. %, such as at least 27 wt. %, such as at least 30 wt. %, such as at least 32 wt. % of units derived from another alpha olefin as described herein. The propylene-based elastomer may contain 38 wt. % or less, such as 35 wt. % or less, such as 33 wt. % or less, such as 30 wt. % or less, such as 28 wt. % or less, such as 25 wt. % or less, such as 23 wt. % or less, such as 20 wt. % or less, such as 18 wt. % or less, such as 15 wt. % or less, such as 13 wt. % or less, such as 10 wt. % or less, such as 8 wt. % or less, such as 6 wt. % or less of units derived from another alpha olefin as described herein.

The propylene-based elastomer may contain at least 16 mol %, such as at least 18 mol %, such as at least 20 mol %, such as at least 22 mol %, such as at least 25 mol %, such as at least 27 mol %, such as at least 30 mol %, such as at least 32 mol %, such as at least 35 mol %, such as at least 37 mol % of units derived from another alpha olefin as described herein. The propylene-based elastomer may contain 40 mol % or less, such as 38 mol % or less, such as 35 mol % or less, such as 33 mol % or less, such as 30 mol % or less, such as 28 mol % or less, such as 25 mol % or less, such as 23 mol % or less, such as 20 mol % or less of units derived from another alpha olefin as described herein.

The propylene-based elastomer may be a block copolymer in one embodiment. In another embodiment, the propylene-based elastomer may be a random copolymer.

The propylene-based elastomer may not be a graft elastomer or copolymer in one embodiment. In this regard, in one embodiment, the propylene-based elastomer may not have grafts of covalent bonded moieties to the chain of the elastomer.

The propylene-based elastomer may have a triad tacticity of three propylene units, as measured by ¹³C NMR, of at least about 50%, such as at least about 60%, such as at least about 70%, such as at least about 75%, such as at least about 80%, such as at least about 82%, such as at least about 85%, such as at least about 90%. The propylene-based elastomer may have a triad tacticity of about 99% or less, such as about 97% or less, such as about 95% or less.

The propylene-based elastomer may have a heat of fusion (“H_{f}”), as determined by DSC, of about 80 J/g or less, such as about 70 J/g or less, such as about 50 J/g or less, such as about 40 J/g or less. The propylene-based elastomer may have a lower limit Hr of about 0.5 J/g, such as about 1 J/g, such as about 5 J/g. For example, the Hr value may range from about 1.0 J/g, 1.5 J/g, 3.0 J/g, 4.0 J/g, 6.0 J/g, or 7.0 J/g to about 30 J/g, 35 J/g, 40 J/g, 50 J/g, 60 J/g, 70 J/g, 75 J/g, or 80 J/g.

The propylene-based elastomer may have a percent crystallinity, as determined according to the DSC procedure described herein, of about 0.25% or more, such as about 0.5% or more, such as about 1% or more, such as about 2% or more, such as about 5% or more, such as about 10% or more, such as about 20% or more, such as about 30% or more. The percent crystallinity may be 65% or less, such as about 40% or less, such as about 35% or less, such as about 30% or less, such as about 25% or less, such as about 20% or less, such as about 15% or less, such as about 10% or less. Such percent crystallinity may be based on the crystallinity of isotactic polypropylene.

The propylene-based elastomer may have a tacticity index m/r from a lower limit of about 4, or about 6, to an upper limit of about 8, or about 10, or about 12. In some embodiments, the propylene-based elastomer may have an isotacticity index greater than 0%, or within the range having an upper limit of about 50%, or about 25%, and a lower limit of about 3%, or about 10%.

The propylene-based elastomer may have a single peak melting transition as determined by DSC. In some embodiments, the propylene-based elastomer may have a primary peak transition of about 90° C. or less, such as 100° C. or less, such as 110° C. or less, such as 120° C. or less, such as 130° C. or less, such as 140° C. or less with a broad end-of-melt transition of about 160° C. or greater, such as about 170° C. or greater 180° C. or greater 190° C. or greater 200° C. or greater. The peak “melting point” (“Tₘ”) is defined as the temperature of the greatest heat absorption within the range of melting of the sample. However, the copolymer may show secondary melting peaks adjacent to the principal peak and/or at the end-of-melt transition. For the purposes of this disclosure, such secondary melting peaks are considered together as a single melting point, with the highest of these peaks being considered the Tₘ of the propylene-based elastomer. The propylene-based elastomer may have a Tₘ of about 100° C. or more, such as about 110° C. or more, such as about 120° C. or more, such as about 130° C. or more, such as about 140° C. or more, such as about 150 or more. The Tₘ may be about 250° C. or less, such as about 220° C. or less, such as about 200° C. or less, such as about 190° C. or less, such as about 180° C. or less, such as about 170° C. or less.

The propylene-based elastomer may have a softening point of about 60° C. or more, such as about 70° C. or more, such as about 80° C. or more, such as about 90° C. or more, such as about 100° C. or more, such as about 110° C. or more, such as about 120° C. or more, such as about 130° C. or more. The softening point may be about 170° C. or less, such as about 160° C. or less, such as about 150° C. or less, such as about 140° C. or less, such as about 130° C. or less.

The propylene-based elastomer may have a density of about 0.850 g/cm³ to about 0.900 g/cm³, or about 0.860 g/cm³ to about 0.880 g/cm³, at room temperature as measured per ASTM D1505-18.

The propylene-based elastomer may have a melt flow rate (“MFR”), as measured per ASTM D1238-10 (2.16 kg at 230° C.) of at least about 1 g/10 min, such as at least about 2 g/10 min, such as at least about 4 g/10 min, such as at least about 6 g/10 min, such as at least about 8 g/10 min, such as at least about 10 g/10 min. The MFR may be about 20 g/10 min or less, such as about 16 g/10 min or less, such as about 12 g/10 min or less, such as about 10 g/10 min or less, such as about 8 g/10 min or less, such as about 7 g/10 min or less, such as about 6 g/10 min or less, such as about 5 g/10 min or less, such as about 4 g/10 min or less, such as about 3 g/10 min or less. In one embodiment, such aforementioned MFR may have been measured at 190° C.

The propylene-based elastomer may have an elongation at break of 500% or more, such as 600% or more, such as 700% or more, such as 800% or more, such as 900% or more, such as 1000% or more, such as 1100% or more, such as 1200% or more. The elongation at break may be 3000% or less, such as 2600% or less, such as 2200% or less, such as 2000% or less, such as 1800% or less, such as 1600% or less, such as 1400% or less, such as 1200% or less, such as 1000% or less. The elongation at break may be measured per ASTM D638-14.

The propylene-based elastomer may have a Shore A hardness of 30 or more, such as 40 or more, such as 50 or more, such as 55 or more, such as 60 or more, such as 65 or more, such as 70 or more, such as 75 or more, such as 80 or more, such as 85 or more. The Shore A hardness may be 100 or less, such as 95 or less, such as 90 or less, such as 85 or less, such as 80 or less, such as 75 or less, such as 70 or less, such as 65 or less, such as 60 or less. The Shore A hardness may be determined in accordance with ASTM 2240-15(2021) (15 seconds).

The compositions disclosed herein may include one or more different propylene-based elastomers. For instance, they may have one or more different properties such as, for example, different comonomers or comonomer content. Such combinations of various propylene-based elastomers are all within the scope of the disclosure.

The propylene-based elastomer may have a molecular weight of 1,000 g/mol or more, such as 2,500 g/mol or more, such as 5,000 g/mol or more, such as 10,000 g/mol or more, such as 20,000 g/mol or more, such as 30,000 g/mol or more, such as 50,000 g/mol or more, such as 70,000 g/mol or more, such as 100,000 g/mol or more, such as 150,000 g/mol or more, such as 200,000 g/mol or more. The molecular weight may be 5,000,000 g/mol or less, such as 4,000,000 g/mol or less, such as 3,000,000 g/mol or less, such as 2,500,000 g/mol or less, such as 2,000,000 g/mol or less, such as 1,500,000 g/mol or less, such as 1,000,000 g/mol or less, such as 500,000 g/mol or less, such as 400,000 g/mol or less, such as 300,000 g/mol or less, such as 250,000 g/mol or less, such as 200,000 g/mol or less, such as 150,000 g/mol or less, such as 130,000 g/mol or less, such as 100,000 g/mol or less, such as 80,000 g/mol or less, such as 60,000 g/mol or less, such as 50,000 g/mol or less. The aforementioned molecular weight may be a number average molecular weight in one embodiment. The aforementioned molecular weight may be a weight average molecular weight in one embodiment.

The propylene-based elastomer may have a molecular weight distribution (“MWD”) of about 1.5 to about 20, such as about 1.5 to about 15, such as about 1.5 to about 5, such as about 1.8 to about 3, such as about 1.8 to about 2.5.

The propylene-based elastomer may be present in an amount of about 3 phr or more, such as about 5 phr or more, such as about 8 phr or more, such as about 10 phr or more, such as about 13 phr or more, such as about 15 phr or more, such as about 20 phr or more, such as about 25 phr or more, such as about 30 phr or more, such as about 40 phr or more. The propylene-based elastomer may be present in an amount of about 70 phr or less, such as about 60 phr or less, such as about 50 phr or less, such as about 40 phr or less, such as about 30 phr or less, such as about 25 phr or less, such as about 20 phr or less, such as about 18 phr or less, such as about 15 phr or less, such as about 13 phr or less, such as about 10 phr or less, such as about 8 phr or less, such as about 5 phr or less.

The thermoplastic vulcanizate and corresponding formulation and composition may generally comprise about 0.5 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 5 wt. % or more, such as about 8 wt. % or more, such as about 10 wt. % or more, such as 13 wt. % or more, such as 15 wt. % or more of the propylene-based elastomer. The thermoplastic vulcanizate and corresponding formulation and composition may comprise about 25 wt. % or less, such as about 20 wt. % or less, such as about 15 wt. % or less, such as about 10 wt. % or less, such as about 8 wt. % or less, such as about 6 wt. % or less, such as about 5 wt. % or less, such as about 4.5 wt. % or less, such as about 4 wt. % or less, such as about 3.5 wt. % or less, such as about 3 wt. % or less, such as about 2.5 wt. % or less of the propylene-based elastomer. In one embodiment, such aforementioned weight percentages may be based on the combined weight of the propylene-based elastomer and the rubber combined within the thermoplastic vulcanizate and/or corresponding formulation and composition. In one embodiment, such aforementioned weight percentages may be based on the combined weight of the thermoplastic resin, the propylene-based elastomer, and the rubber combined within the thermoplastic vulcanizate and/or corresponding formulation and composition.

### D. Curing Composition

As indicated herein, the TPV formulation, in particular the rubber within the formulation, can undergo dynamic vulcanization wherein the rubber is at least partially cured. In general, any curing agent that is capable of curing or crosslinking the rubber may be used. Some non-limiting examples of these curing agents include phenolic resins, peroxides, maleimides, and silicon-containing curing agents. The curing agents may be used with one or more coagents that serve as initiators, catalysts, etc. for purposes of improving the overall cure state of the rubber. For instance, the curing composition of some embodiments includes one or both of zinc oxide (ZnO) and stannous chloride (SnCl₂).

In general, the phenolic resins may not necessarily be limited. For instance, these may include resole resins made by the condensation of alkyl substituted phenols or unsubstituted phenols with aldehydes, which can be formaldehydes, in an alkaline medium or by condensation of bi-functional phenoldialcohols. The alkyl substituents of the alkyl substituted phenols typically contain 1 to about 10 carbon atoms. Dimethylol phenols or phenolic resins, substituted in para-positions with alkyl groups containing 1 to about 10 carbon atoms can be used. These phenolic curing agents may be thermosetting resins and may be referred to as phenolic resin curing agents or phenolic resins. These phenolic resins may be ideally used in conjunction with a catalyst system. For example, non-halogenated phenol curing resins are used in conjunction with halogen donors and, optionally, a hydrogen halide scavenger. Where the phenolic curing resin is halogenated, a halogen donor is not required but the use of a hydrogen halide scavenger, such as ZnO, can be used.

Peroxide curing agents are generally selected from organic peroxides. Examples of organic peroxides include, but are not limited to, di-tert-butyl peroxide, dicumyl peroxide, t-butylcumyl peroxide, alpha, alpha-bis(tert-butylperoxy)diisopropyl benzene, 2,5 dimethyl 2,5-di(t-butylperoxy)hexane, 1,1-di(t-butylperoxy)-3,3,5-trimethyl cyclohexane, benzoyl peroxide, lauroyl peroxide, dilauroyl peroxide, 2,5-dimethyl-2,5-di(tert-butylperoxy)hexyne-3, and mixtures thereof. Also, diaryl peroxides, ketone peroxides, peroxydicarbonates, peroxyesters, dialkyl peroxides, hydroperoxides, peroxyketals and mixtures thereof may be used.

The silicon-containing curing agents generally include silicon hydride compounds having at least two SiH groups. These compounds react with carbon-carbon double bonds of unsaturated polymers in the presence of a hydrosilylation catalyst. Silicon hydride compounds include, but are not limited to, methylhydrogen polysiloxanes, methylhydrogen dimethyl-siloxane copolymers, alkyl methyl polysiloxanes, bis(dimethylsilyl)alkanes, bis(dimethylsilyl)benzene, and mixtures thereof.

As noted above, hydrosilylation curing may be conducted in the presence of a catalyst. These catalysts can include, but are not limited to, peroxide catalysts and catalysts including transition metals of Group VIII. These metals include, but are not limited to, palladium, rhodium, and platinum, as well as complexes of these metals.

In certain embodiments, the curing composition also includes one or both of ZnO and SnCl₂. In one embodiment, the curing composition may include zinc oxide. In another embodiment, the curing composition may include stannous chloride. In a further embodiment, the curing composition may include zinc oxide and stannous chloride.

Coagents may also be employed with the curing agents, such as the phenolic resin and/or peroxides. The coagent may include a multi-functional acrylate ester, a multi-functional methacrylate ester, or combination thereof. In other words, the coagents include two or more organic acrylate or methacrylate substituents. Examples of multi-functional acrylates include diethylene glycol diacrylate, trimethylolpropane triacrylate (TMPTA), ethoxylated trimethylolpropane triacrylate, propoxylated trimethylolpropane triacrylate, propoxylated glycerol triacrylate, pentaerythritol triacrylate, bistrimethylolpropane tetraacrylate, pentaerythritol tetraacrylate, ethoxylated pentaerythritol tetraacrylate, ethoxylated pentaerythritol triacrylate, cyclohexane dimethanol diacrylate, ditrimethylolpropane tetraacrylate, or combinations thereof. Examples of multi-functional methacrylates include trimethylol propane trimethacrylate (TMPTMA), ethylene glycol dimethacrylate, butanediol dimethacrylate, butylene glycol dimethacrylate, diethylene glycol dimethacrylate, polyethylene glycol dimethacrylate, allyl methacrylate, or combinations thereof. The coagent may also include triallylcyanurate, triallyl isocyanurate, triallyl phosphate, sulfur, N-phenyl-bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, oximer for e.g., quinone dioxime, and the like.

Furthermore, an oil can be employed in the cure system. The oil may also be referred to as a process oil, an extender oil, or plasticizer. Useful oils include mineral oils, synthetic processing oils, or combinations thereof and may act as plasticizers. The plasticizers include, but are not limited to, aromatic, naphthenic, and extender oils. Exemplary synthetic processing oils include low molecular weight polylinear alpha-olefins, and polybranched alpha-olefins. Suitable esters include monomeric and oligomeric materials having an average molecular weight below about 2,000 g/mole, or below about 600 g/mole. Specific examples include aliphatic mono- or diesters or alternatively oligomeric aliphatic esters or alkyl ether esters.

The curing composition may be added in one or more locations, including the feed hopper of a melt mixing extruder. In some embodiments, the curing agent and any additional coagents may be added to the TPV formulation together; in other embodiments, one or more coagents may be added to the TPV formulation at different times from any one or more of the curing agents, as the TPV formulation is undergoing processing to form a TPV.

In general, the amount of curing agent present should be sufficient to at least partially vulcanize the rubber and in some embodiments, to completely vulcanize the rubber. For instance, the curing composition may be present in an amount of 1 phr or more, such as 2 phr or more, such as 3 phr or more, such as 5 phr or more, such as 8 phr or more, such as 10 phr or more, such as 12 phr or more, such as 14 phr or more, such as 16 phr or more, such as 18 phr or more, such as 20 phr or more. The curing composition may be present in an amount of 40 phr or less, such as 35 phr or less, such as 30 phr or less, such as 28 phr or less, such as 25 phr or less, such as 23 phr or less, such as 21 phr or less, such as 20 phr or less, such as 18 phr or less, such as 16 phr or less, such as 14 phr or less, such as 12 phr or less, such as 10 phr or less. Similarly, the curing agent may be present in an amount of 1 phr or more, such as 2 phr or more, such as 3 phr or more, such as 5 phr or more, such as 8 phr or more, such as 10 phr or more, such as 12 phr or more, such as 14 phr or more, such as 16 phr or more, such as 18 phr or more, such as 20 phr or more. The curing agent may be present in an amount of 40 phr or less, such as 35 phr or less, such as 30 phr or less, such as 28 phr or less, such as 25 phr or less, such as 23 phr or less, such as 21 phr or less, such as 20 phr or less, such as 18 phr or less, such as 16 phr or less, such as 14 phr or less, such as 12 phr or less, such as 10 phr or less.

### E. Oil

The thermoplastic vulcanizate and corresponding formulation and/or composition as disclosed herein also comprise an oil. For instance, the oil includes, but is not limited to, a plasticizer oil, a process oil, an extender oil, or a mixture thereof, and the like. In this regard, the resulting thermoplastic vulcanizate and corresponding composition may also comprise one or more of such oils. The oil may be a virgin oil, a re-refined oil, or a mixture thereof.

Any suitable oil may be included in some embodiments. In particular embodiments, oils may be selected from: (i) extension oil, that is, oil present in an oil-extended rubber (such as oil present with the rubber); (ii) free oil, that is, oil that is added during the vulcanization process (separately from any other TPV formulation component such as the rubber and thermoplastic vulcanizate); (iii) curative oil, that is, oil that is used to dissolve/disperse the curing agents, for example, a curative-in-oil dispersion such as a phenolic resin-in-oil (and in such embodiments, the curing composition may therefore be present in the TPV formulation as the curative-in-oil additive); and (iv) any combination of the foregoing oils from (i)-(iii). Thus, oil may be present in a TPV formulation as part of another component (e.g., as part of the rubber when the process oil is an extension oil, such that the rubber comprises rubber and extension oil; or as part of the curing composition when the process oil is the carrier of a curative-in-oil, such that the curing composition comprises the curative oil and a curing agent). On the other hand, oil may be added to the TPV separately from other components, i.e., as free oil.

In one embodiment, the oil may be provided separately from any other component in the formulation. In another embodiment, the oil may be an extension oil such that it is provided with the rubber. In this regard, such rubber may be an oil extended rubber.

The extension oil, free oil, and/or curative oil may be the same or different oils in various embodiments. Process oils may include one or more of (i) “refined” or “mineral” oils, and (ii) synthetic oils. As used herein, mineral oils refer to any hydrocarbon liquid of lubricating viscosity (i.e., a kinematic viscosity at 100° C. of 1 mm²/sec or more) derived from petroleum crude oil and subjected to one or more refining and/or hydroprocessing steps (such as fractionation, hydrocracking, dewaxing, isomerization, and hydrofinishing) to purify and chemically modify the components to achieve a final set of properties. Such “refined” oils are in contrast to “synthetic” oils, which are manufactured by combining monomer units into larger molecules using catalysts, initiators, and/or heat.

In general, either refined or synthetic process oils according to some embodiments may include, but are not limited to, any one or more of aromatic, naphthenic, and paraffinic oils. Exemplary synthetic processing oils are polylinear alpha-olefins, polybranched alpha-olefins, and hydrogenated polyalphaolefins. The compositions of some embodiments of this invention may include organic esters, alkyl ethers, or combinations thereof.

In certain embodiments, at least a portion of the oil (e.g., all or a portion of any one or more of extension oil, free oil, and/or curative oil) is a low aromatic/sulfur content oil and has (i) an aromatic content of less than 5 wt. %, or less than 3.5 wt. %, or less than 1.5 wt. %, based on the weight of that portion of the oil; and (ii) a sulfur content of less than 0.3 wt. %, or less than 0.003 wt. %, based on the weight of that portion of the oil. Aromatic content may be determined in a manner consistent with method ASTM D2007. The percentage of aromatic carbon in the process oil of some embodiments is preferably less than 2, 1, or 0.5%. In certain embodiments, there are no aromatic carbons in the process oil. The proportion of aromatic carbon (%) as used herein is the proportion (percentage) of the number of aromatic carbon atoms to the number of all carbon atoms determined by the method in accordance with ASTM D2140.

Suitable oils of particular embodiments may include API Group I, II, III, IV, and V base oils. See API 1509, Engine Oil Licensing and Certification System, 17th Ed., September 2012, Appx. E, incorporated herein by reference.

The oil may have a particular viscosity index as determined in accordance with ASTM D2270. For instance, the viscosity index may be 80 or more, such as 85 or more, such as 90 or more, such as 95 or more, such as 100 or more, such as 105 or more, such as 110 or more, such as 115 or more. The viscosity index may be 180 or less, such as 170 or less, such as 160 or less, such as 150 or less, such as 140 or less, such as 130 or less, such as 125 or less, such as 120 or less, such as 115 or less, such as 110 or less.

Aside from the viscosity index, the oil may have a particular kinematic viscosity as determined in accordance with ASTM D7279. For instance, at 40° C., the kinematic viscosity may be 15 cSt or more, such as 18 cSt or more, such as 21 cSt or more, such as 24 cSt or more, such as 27 cSt or more, such as 30 cSt. The kinematic viscosity at 40° C. may be 70 cSt or less, such as 60 cSt or less, such as 50 cSt or less, such as 45 cSt or less, such as 42 cSt or less, such as 39 cSt or less, such as 36 cSt or less, such as 33 cSt or less, such as 30 cSt or less, such as 27 cSt or less, such as 24 cSt or less. The kinematic viscosity at 100° C. may be 0.5 cSt or more, such as 1 cSt or more, such as 1.5 cSt or more, such as 2 cSt or more, such as 2.3 cSt or more, such as 2.6 cSt or more, such as 2.9 cSt or more, such as 3.3 cSt or more, such as 3.6 cSt or more, such as 3.9 cSt or more, such as 4.2 cSt or more, such as 4.6 cSt or more, such as 5 cSt or more. The kinematic viscosity at 100° C. may be 12 cSt or less, such as 10 cSt or less, such as 8 cSt or less, such as 7.6 cSt or less, such as 7.2 cSt or less, such as 6.8 cSt or less, such as 6.4 cSt or less, such as 6 cSt or less, such as 5.6 cSt or less, such as 5.2 cSt or less, such as 4.8 cSt or less, such as 4.4 cSt or less, such as 4 cSt or less.

Also, the oil may have a particular pour point as determined in accordance with ASTM D5949. For instance, the pour point may be 15° C. or less, such as 10° C. or less, such as 5° C. or less, such as 0° C. or less, such as −2° C. or less, such as −5° C. or less, such as −8° C. or less, such as −10° C. or less, such as −12° C. or less, such as −15° C. or less, such as −18° C. or less, such as −20° C. or less, such as −25° C. or less. The pour point may be −60° C. or more, such as −50° C. or more, such as −40° C. or more, such as −30° C. or more, such as −26° C. or more, such as −22° C. or more, such as −20° C. or more, such as −16° C. or more, such as −12° C. or more, such as −9° C. or more, such as −6° C. or more.

The oil may be a re-refined oil in one embodiment. As utilized herein, “re-refined oil” refers to used or waste oil that has gone through a process similar to the original process of preparing crude oil for use (e.g., filtration, distillation, and/or dehydration, etc.). As examples, the “re-refined oil” may be obtained from the waste oil of an automobile garage during car service and/or from metal cutting industries who use oil during their process. During such refining process generally, contaminants can be removed. Re-refined oils may also include those re-refined oils based on any other oils disclosed below.

In this regard, in one embodiment, at least 85 wt. %, such as at least 90 wt. %, such as at least 93 wt. %, such as at least 95 wt. %, such as at least 97 wt. %, such as at least 98 wt. %, such as at least 99 wt. % of the re-refined oil may be the oil. For instance, the balance may be a contaminant. In this regard, less than 10 wt. %, such as less than 8 wt. %, such as less than 6 wt. %, such as less than 5 wt. %, such as less than 4 wt. %, such as less than 3 wt. %, such as less than 2 wt. %, such as less than 1 wt. % of the re-refined oil may be contaminants.

Particularly, the re-refined oil may have a sulfur content of 1000 ppm or less, such as 800 ppm or less, such as 600 ppm or less, such as 500 ppm or less, such as 400 ppm or less, such as 300 ppm or less, such as 200 ppm or less, such as 150 ppm or less, such as 100 ppm or less, such as 80 ppm or less, such as 50 ppm or less, such as 30 ppm or less, such as 20 ppm or less, such as 10 ppm or less. The sulfur content may be determined in accordance with ASTM D5185.

Also, the re-refined oil may have a polycyclic aromatics content of 5 wt. % or less, such as 4.5 wt. % or less, such as 4 wt. % or less, such as 3.5 wt. % or less, such as 3 wt. % or less, such as 2.5 wt. % or less, such as 2 wt. % or less, such as 1.5 wt. % or less, such as 1 wt. % or less. The polycyclic aromatics content may be determined in accordance with IP 346.

In addition, the re-refined oil may include 80 wt. % or more, such as 85 wt. % or more, such as 90 wt. % or more, such as 92 wt. % or more, such as 94 wt. % or more, such as 95 wt. % or more, such as 96 wt. % or more, such as 97 wt. % or more, such as 98 wt. % or more, such as 99 wt. % or more of saturates.

The purity of the re-refined oil may also be indicated by the color as determined in accordance with ASTM D1500. For instance, the re-refined oil may have a color value of 2 or less, such as 1.5 or less, such as 1.0 or less, such as 0.5 or less.

In certain embodiments, in addition to the re-refined oil, the oil may also comprise a virgin oil. In this regard, a virgin oil may be an oil not considered to be a re-refined oil. For instance, such oil may not be considered a waste or used oil that has been re-refined. Accordingly, in one embodiment, the oil may comprise a mixture of a re-refined oil and a virgin oil.

The oil may be present in the formulation and/or thermoplastic vulcanizate in an amount of 10 phr or more, such as 20 phr or more, such as 30 phr or more, such as 40 phr or more, such as 50 phr or more, such as 60 phr or more, such as 70 phr or more, such as 80 phr or more, such as 90 phr or more, such as 100 phr or more, such as 110 phr or more, such as 120 phr or more, such as 130 phr or more, such as 150 phr or more, such as 180 phr or more, such as 200 phr or more. The oil may be present in the formulation and/or thermoplastic vulcanizate in an amount of 350 phr or less, such as 300 phr or less, such as 280 phr or less, such as 250 phr or less, such as 220 phr or less, such as 200 phr or less, such as 180 phr or less, such as 160 phr or less, such as 150 phr or less, such as 140 phr or less, such as 130 phr or less, such as 120 phr or less, such as 110 phr or less, such as 100 phr or less.

The thermoplastic vulcanizate and corresponding formulation and/or composition can generally comprise about 2 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 40 wt. % or more, such as about 45 wt. % or more, such as about 50 wt. % or more of the oil. The thermoplastic vulcanizate and corresponding formulation and/or composition may comprise about 70 wt. % or less, such as about 65 wt. % or less, such as about 60 wt. % or less, such as about 55 wt. % or less, such as about 50 wt. % or less, such as about 40 wt. % or less, such as about 35 wt. % or less, such as about 30 wt. % or less, such as about 25 wt. % or less, such as about 20 wt. % or less, such as about 15 wt. % or less of the oil.

Of the total oil provided, a majority of such oil may be provided as a free oil in one embodiment. For instance, 50 wt. % or more, such as 60 wt. % or more, 70 wt. % or more, such as 75 wt. % or more, such as 80 wt. % or more, such as 85 wt. % or more, such as 90 wt. % or more, such as 95 wt. % or more of the oil may be a free oil. The remaining oil may be an extension oil and/or a curative oil. For instance, 50 wt. % or less, such as 40 wt. % or less, such as 30 wt. % or less, such as 20 wt. % or less, such as 15 wt. % or less, such as 10 wt. % or less, such as 8 wt. % or less, such as 5 wt. % or less of the oil may be an extension oil and/or a curative oil.

In another embodiment, the oil may be primarily provided as an extension oil rather than a free oil and/or a curative oil. For instance, of the oil provided, 50 wt. % or more, such as 60 wt. % or more, 70 wt. % or more, such as 75 wt. % or more, such as 80 wt. % or more, such as 85 wt. % or more, such as 90 wt. % or more, such as 95 wt. % or more, such as 98 wt. % or more, such as about 100 wt. % may be provided as an extension oil. The remaining oil may be a free oil and/or a curative oil.

### F. Other Additives

The thermoplastic vulcanizate and corresponding formulation and composition of some embodiments may optionally further comprise one or more additives. Suitable additional additives include, but are not limited to, fillers (e.g., organic fillers, inorganic fillers, minerals, etc.), reinforcing agents, process oils, process aids, plasticizers, stabilizers (e.g., heat stabilizers; UV light stabilizers; metal deactivators; antioxidants such as phenolic, phosphite, and/or amine containing antioxidants; acid scavengers; etc.), viscosity modifiers, nucleating agents, lubricants (e.g., silicone), waxes, flow enhancing additives, flame retardants (e.g., phosphates such as polyphosphates, pyrophosphates, etc.; phosphinates; etc.), impact modifiers, antiblocking agents, antistatic agents, antimicrobial agents, foaming agents, colorants, pigments and/or the like. In this regard, the resulting thermoplastic vulcanizate and corresponding composition may also comprise one or more of such additives.

A thermoplastic vulcanizate and corresponding formulation and composition of some embodiments may include reinforcing and/or non-reinforcing fillers. Fillers and extenders that can be utilized include conventional inorganics such as calcium carbonate, clays, silica, talc, titanium dioxide, as well as organic, such as carbon black, graphene, and organic and inorganic nanoscopic fillers. In one embodiment, such filler may be a glass filler, such as glass fibers, glass beads, mixtures thereof, etc. In one embodiment, the formulation and resulting thermoplastic vulcanizate may include a clay. In one embodiment, the formulation and resulting thermoplastic vulcanizate may include carbon black.

In certain embodiments, the TPV and/or formulation and composition may include one or more antioxidants. For instance, the antioxidant may be a phenolic, a phosphite, and/or an amine containing antioxidant. In one embodiment, the antioxidant may be a phenolic antioxidant, such as a sterically hindered phenolic antioxidant. In another embodiment, the antioxidant may be a phosphite antioxidant. In a further embodiment, the antioxidant may be an amine antioxidant.

In certain embodiments, the TPV and/or formulation and composition may include one or more lubricants. For instance, the lubricant may include a silicone in one embodiment. For instance, the silicone may be a siloxane polymer, in particular an ultra-high molecular weight siloxane polymer.

These additives can be utilized in an amount to provide the desired effect. In this regard, the additives may be present in an amount of up to about 50 weight percent of the thermoplastic vulcanizate and corresponding formulation and composition. In this regard, a respective additive and/or combination of additives may be present in an amount of 0.001 wt. % or more, such as 0.01 wt. % or more, such as 0.05 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 3 wt. % or more, such as 5 wt. % or more, such as 8 wt. % or more, such as 10 wt. % or more, such as 12 wt. % or more, such as 15 wt. % or more, such as 20 wt. % or more, such as 25 wt. % or more, such as 30 wt. % or more. They may be present in an amount of 50 wt. % or less, such as 40 wt. % or less, such as 30 wt. % or less, such as 25 wt. % or less, such as 20 wt. % or less, such as 18 wt. % or less, such as 15 wt. % or less, such as 13 wt. % or less, such as 10 wt. % or less, such as 8 wt. % or less, such as 6 wt. % or less, such as 4 wt. % or less, such as 3 wt. % or less, such as 2 wt. % or less, such as 1 wt. % or less, such as 0.5 wt. % or less. In another embodiment, such aforementioned percentages may be based on the weight of the thermoplastic resin. In a further embodiment, such aforementioned percentages may be based on the weight of the rubber. In an even further embodiment, such aforementioned percentages may be based on the combined weight of the thermoplastic resin and rubber. In another further embodiment, such aforementioned percentages may be based on the weight of the thermoplastic resin, rubber, and the propylene-based elastomer.

### G. TPV Formulation

In general, as used herein, a “TPV formulation” refers to the mixture of ingredients blended or otherwise compiled before or during processing of the TPV formulation in order to form a thermoplastic vulcanizate. This is in recognition of the fact that the ingredients that are mixed together and then processed may or may not be present in the final TPV in the same amounts added to the formulation, depending upon the reactions that take place among some or all of the ingredients during processing of the mixed ingredients.

In general, a TPV formulation according to various embodiments includes the thermoplastic resin, the rubber, curing agent (or curing composition), and oil along with any other optional additives. In one embodiment, the TPV formulation may also include the propylene-based elastomer. For instance, such component may be blended with the thermoplastic vulcanizate in forming a thermoplastic vulcanizate composition after dynamic vulcanization and formation of the thermoplastic vulcanizate.

As will be discussed in more detail below, the TPV formulation undergoes processing, including dynamic vulcanization or dynamic curing, to form a TPV. In certain embodiments, any other additives may be added during processing, either before or after dynamic vulcanization.

Relative amounts of the various components in TPV formulations are conveniently characterized based upon the amount of rubber in the formulation, in particular in parts by weight per hundred parts by weight of rubber (phr). In embodiments wherein the rubber comprises both rubber with an extension oil, as is common for much commercially available rubbers such as EPDM, the phr amounts are based only upon the amount of rubber, exclusive of extension oil present with the rubber. Thus, as an example, a rubber containing 100 parts EPDM (rubber) and 75 parts extension oil would in fact be considered present in a TPV formulation at 175 phr (i.e., on the basis of the 100 parts EPDM rubber). If such a TPV formulation were further characterized as containing 50 phr thermoplastic resin, the formulation would include 50 parts by weight of thermoplastic resin in addition to the 100 parts by weight rubber and 75 parts by weight extension oil.

TPV formulations of some embodiments may include the thermoplastic resin in an amount from about 3 to about 70 parts per hundred parts by weight of the rubber (phr). In various embodiments, the thermoplastic resin is included in a TPV formulation in an amount ranging from a low of any one of about 3, 5, 10, 15, 20, 25, 30, 35, 40, 45, 50, 55, 60, 65, 70 phr to a high of any one of about 8, 10, 15, 20, 25, 30, 35, 40, 50, 60, 70 phr. The thermoplastic resin may be included in an amount ranging from any of the aforementioned lows to any of the aforementioned highs, provided that the high value is greater than or equal to the low value. In particular embodiments, increasing amounts of thermoplastic resin correspond to increasing hardness of the dynamically vulcanized TPV.

When the rubber consists of rubber only, it is by definition present at 100 phr (since it is the basis of the phr notation). However, in embodiments wherein the rubber component comprises a constituent other than a rubber, such as an extender oil, the rubber may be included in a TPV formulation in an amount ranging from a low of any one of about 100.05, 100.1, 100.15, 100.2, 105, 110, 115, 120, 130, 140, 150 phr to a high of any one of about 110, 120, 125, 150, 175, 200, 225, 250, and 300 phr.

In embodiments wherein the propylene-based elastomer is provided in the TPV formulation prior to dynamic vulcanization, it may be present in an amount from about 3 to about 70 parts per hundred parts by weight of the rubber (phr). In various embodiments, the compatibilizer is included in a TPV formulation in an amount ranging from a low of any one of about 3, 5, 10, 15, 20, 25, 30, 35, 40, 45, 50, 55, 60, 65, 70 phr to a high of any one of about 8, 10, 15, 20, 25, 30, 35, 40, 50, 60, 70 phr. The propylene-based elastomer may be included in an amount ranging from any of the aforementioned lows to any of the aforementioned highs, provided that the high value is greater than or equal to the low value.

As previously noted, TPV formulations of certain embodiments may optionally include additional TPV additives. Amounts of additional additive are separate and in addition to those additives already included in another component of a TPV formulation. Additional additives may be present in a TPV formulation in the aggregate in an amount ranging from about 0 phr to about 300 phr. In certain embodiments, additional additives may in the aggregate be present in the TPV in an amount ranging from a low of any one of about 0, 5, 10, 15, 25, 30, 40, 50, 60, 70, 80, 90, and 100 phr, to a high of any one of about 25, 30, 40, 50, 60, 80, 100, 125, 150, 175, 200, 225, 250, 275, and 300 phr. The additional additives may be included in an aggregate amount ranging from any one of the aforementioned lows to any one of the aforementioned highs, provided that the high value is greater than or equal to the low value. In one embodiment, such aforementioned phr may refer to the additional additives individually rather than the aggregate.

For convenience, components of TPV formulations of various embodiments may alternatively be characterized based upon their weight percentages in the TPV formulation according to the following:

The thermoplastic resin(s) may be present in a TPV formulation in amounts ranging from a low of any one of about 0.5, 1, 1.5, 2, 2.5, 3, 3.5, 4, 4.5, 5, 6, 7, 8, 9, 10, 11, 12, 13, 14, 15, 16, 17, 18, 19, 20 wt. % to a high of any one of about 1.5, 2, 2.5, 3, 3.5, 4, 4.5, 5, 6, 7, 8, 9, 10, 11 12, 13, 14, 15, 16, 17, 18, 19, 20, 21, 22, 23, 24, 25 wt. %, provided that the high is greater than or equal to the low.

The rubber(s) may be present in a TPV formulation in amounts ranging from a low of any one of about 3, 4, 5, 6, 7, 8, 9, 10, 11, 12, 13, 14, 15, 16, 17, 18, 19, 20 wt. % to a high of any one of about 25, 30 35, 40, 45, 50, 55, 60, 65, 70, 75, and 80 wt. %, provided that the high is greater than or equal to the low.

The compatibilizer(s) may be present in a TPV formulation in amounts ranging from a low of any one of about 0.5, 1, 1.5, 2, 2.5, 3, 3.5, 4, 4.5, 5, 6, 8, 10, 12, 14, 16, 18, 20 wt. % to a high of any one of about 4, 4.5, 5, 6, 7, 8, 9, 10, 11 12, 13, 14, 15, 16, 17, 18, 19, 20, 21, 22, 23, 24, 25 wt. %, provided that the high is greater than or equal to the low.

The optional additional TPV additive(s) may be present in a TPV formulation in aggregate amounts ranging from a low of any one of about 0, 5, 10, 15, 20, 25, 30, 35, and 40 wt. % to a high of any one of about 30, 35, 40, 45, 50, 55, 60, and 65 wt. %, provided that the high is greater than or equal to the low.

### H. Processing TPV Formulations

The thermoplastic vulcanizate of the present disclosure is prepared by dynamic vulcanization techniques. The term “dynamic vulcanization” refers to a vulcanization or curing process for a TPV formulation comprising a rubber, wherein the rubber is vulcanized under conditions of high shear mixing at a temperature above the melting point of the thermoplastic resin to produce a thermoplastic vulcanizate. In dynamic vulcanization, a rubber is simultaneously crosslinked and dispersed as fine particles within the thermoplastic resin or matrix, although other morphologies, such as co-continuous morphologies, may exist depending on the degree of cure, the rubber to resin viscosity ratio, the intensity of mixing, the residence time, and the temperature.

In this regard, the present disclosure is directed to a method of dynamically vulcanizing or dynamically curing a formulation comprising a thermoplastic resin, a rubber, an oil, and a curing agent. Accordingly, the dynamic vulcanization occurs in the presence of the oil. In certain embodiments, the formulation may also include a propylene-based elastomer as defined herein.

Such method may in turn provide a thermoplastic vulcanizate comprising the thermoplastic resin and an at least partially cured rubber. For instance, the thermoplastic resin may be provided as a continuous phase or matrix wherein the at least partially cured rubber is provided as a dispersed phase within the continuous thermoplastic phase. Further, in the instance the propylene-based elastomer is also provided in the formulation, the thermoplastic vulcanizate may also include such component.

In some embodiments, processing may include melt blending, in a chamber, a TPV formulation comprising the thermoplastic resin, rubber, and curing agent. Such formulation may also include other components as mentioned herein, such as the propylene-based elastomer. The chamber may be any vessel that is suitable for blending the selected composition under temperature and shearing force conditions necessary to form a thermoplastic vulcanizate. In this respect, the chamber may be a mixer, such as Banbury™ mixers or Brabender™ mixers, and certain mixing extruders such as co-rotating, counter-rotating, and twin-screw extruders, as well as co-kneaders, such as Buss® kneaders. According to one embodiment, the chamber is an extruder, which may be a single or multi-screw extruder. The term “multi-screw extruder” means an extruder having two or more screws; with two and three screw extruders being exemplary, and two or twin-screw extruders being preferred in some embodiments. The screws of the extruder may have a plurality of lobes; two and three lobe screws being preferred. It will readily be understood that other screw designs may be selected in accordance with the methods of embodiments of the present disclosure. In some embodiments, dynamic vulcanization may occur during and/or as a result of extrusion. After discharging from the mixer, the blend containing the vulcanized rubber and the thermoplastic can be milled, chopped, extruded, pelletized, injection-molded, or processed by any other desirable technique.

The dynamic vulcanization of the rubber may be carried out to achieve relatively high shear. In particular embodiments, the blending may be performed at a temperature not exceeding about 400° C., preferably not exceeding about 300° C., and more preferably not exceeding about 250° C. The minimum temperature at which the melt blending is performed is generally higher than or equal to about 130° C., preferably higher than or equal to about 150° C. and more particularly higher than about 180° C. The blending time is chosen by taking into account the nature of the compounds used in the TPV formulation and the blending temperature. The time generally varies from about 5 seconds to about 120 minutes, and in most cases from about 10 seconds to about 30 minutes.

Dynamic vulcanization in some embodiments may include phase inversion. As those skilled in the art appreciate, dynamic vulcanization may begin by including a greater volume fraction of rubber than thermoplastic resin. As such, the thermoplastic resin may be present as the discontinuous phase when the rubber volume fraction is greater than that of the volume fraction of the thermoplastic resin. As dynamic vulcanization proceeds, the viscosity of the rubber increases and phase inversion occurs under dynamic mixing. In other words, upon phase inversion, the thermoplastic resin phase becomes the continuous phase.

Other additive(s) are preferably present within the TPV formulation when dynamic vulcanization is carried out, although in some embodiments, one or more other additives (if any) may be added to the composition after the curing and/or phase inversion (e.g., after the dynamic vulcanization portion of processing). For instance, in one embodiment, at least one propylene-based elastomer may be provided after dynamic vulcanization. However, in one embodiment, the propylene-based elastomer may be provided before or during dynamic vulcanization. In another embodiment, the propylene-based elastomer may be provided after dynamic vulcanization. In this regard, the present disclosure may include a step of melt blending the thermoplastic vulcanizate with at least one propylene-based elastomer. In certain embodiments, the method may include a step of melt blending the thermoplastic vulcanizate with the propylene-based elastomer. The melt blending technique is not necessarily limited by the present disclosure and may include those means mentioned herein, such as mixers, extruders, kneaders, etc.

The additional additives may be included after dynamic vulcanization by employing a variety of techniques. In one embodiment, they can be added while the thermoplastic vulcanizate remains in its molten state from the dynamic vulcanization process. For example, the additional additives can be added downstream of the location of dynamic vulcanization within a process that employs continuous processing equipment, such as a single or twin screw extruder. In other embodiments, the thermoplastic vulcanizate can be “worked-up” or pelletized, subsequently melted, and the additional additives can be added to the molten thermoplastic vulcanizate product. This latter process may be referred to as a “second pass” addition of the ingredients.

Despite the fact that the rubber may be partially or fully cured, the thermoplastic vulcanizate can be processed and reprocessed by conventional plastic processing techniques such as extrusion, injection molding, and compression molding. The rubber within these thermoplastic rubber is usually in the form of finely-divided and well-dispersed particles of vulcanized or cured rubber within a continuous thermoplastic phase or matrix, although a co-continuous morphology or a phase inversion is also possible. In those embodiments where the cured rubber is in the form of finely-divided and well-dispersed particles within the thermoplastic medium, the rubber particles may have an average diameter that is less than 50 μm, such as less than 30 μm, such as less than 10 μm, such as less than 5 μm, such as less than 1 μm. In preferred embodiments, at least 50%, such as at least 60%, such as at least 75% of the rubber particles may have an average diameter of less than 5 μm, such as less than 2 μm, such as less than 1 μm.

The degree of cure can be measured by determining the amount of rubber that is extractable from the thermoplastic vulcanizate by using cyclohexane or boiling xylene as an extractant. Preferably, the rubber may have a degree of cure where not more than 15 weight percent, such as not more than 10 weight percent, such as not more than 5 weight percent, such as not more than 3 weight percent is extractable by cyclohexane at 23° C. as described in U.S. Pat. Nos. 4,311,628, 5,100,947 and 5,157,081, all of which are incorporated herein by reference. Alternatively, the rubber may have a degree of cure such that the crosslink density is at least 4×10⁻⁵, such as at least 7×10⁻⁵, such as at least 10×10⁻⁵ moles per milliliter of rubber. See Crosslink Densities and Phase Morphologies in Dynamically Vulcanized TPEs, by Ellul et al., Rubber Chemistry and Technology, Vol. 68, pp. 573-584 (1995).

The resulting thermoplastic vulcanizate and/or corresponding composition may have the desired specific gravity that allows it to be foamed and/or utilized for a molded part as described herein. In this regard, the specific gravity may be 0.3 g/cm³ or more, such as 0.4 g/cm³ or more, such as 0.5 g/cm³ or more, such as 0.6 g/cm³ or more, such as 0.65 g/cm³ or more, such as 0.7 g/cm³ or more, such as 0.75 g/cm³ or more, such as 0.8 g/cm³ or more, such as 0.85 g/cm³ or more, such as 0.9 g/cm³ or more, such as 0.95 g/cm³ or more, such as 1 g/cm³ or more, such as 1.05 g/cm³ or more, such as 1.1 g/cm³ or more, such as 1.15 g/cm³ or more, such as 1.2 g/cm³ or more. The specific gravity may be 2 g/cm³ or less, such as 1.8 g/cm³ or less, such as 1.6 g/cm³ or less, such as 1.4 g/cm³ or less, such as 1.3 g/cm³ or less, such as 1.2 g/cm³ or less, such as 1.1 g/cm³ or less, such as 1.0 g/cm³ or less, such as 0.95 g/cm³ or less, such 0.90 g/cm³ or less, such as 0.7 g/cm³ or less, such as 0.6 g/cm³ or less, such as 0.55 g/cm³ or less. The specific gravity may be determined at 22.7° C.

### I. Properties

The present inventors have discovered that the properties of the thermoplastic vulcanizate and/or corresponding composition may be desired for a number of applications. In this regard, the thermoplastic vulcanizate and/or corresponding composition may exhibit a certain strength as indicated by certain mechanical properties.

For instance, the thermoplastic vulcanizate and/or corresponding composition may also exhibit a ultimate tensile strength of from 0.5 to 20 MPa, such as from 1 to 10 MPa, such as from 1 to 5 MPa. For instance, the thermoplastic vulcanizate and/or corresponding composition may exhibit a tensile strength of 0.5 MPa or more, such as 0.8 MPa or more, such as 1 MPa or more, such as 1.3 MPa or more, such as 1.5 MPa or more, such as 1.8 MPa or more, such as 2 MPa or more, such as 2.3 MPa or more, such as 2.5 MPa or more, such as 3 MPa or more, such as 3.5 MPa or more, such as 4 MPa or more, such as 4.5 or more, such as 5 MPa or more, such as 5.5 or more, such as 6 MPa or more, such as 7 MPa or more, such as 8 MPa or more, such as 9 MPa or more, such as 10 MPa or more. The ultimate tensile strength may be 20 MPa or less, such as 18 MPa or less, such as 15 MPa or less, such as 13 MPa or less, such as 11 MPa or less, such as 10 MPa or less, such as 9 MPa or less, such as 8 MPa or less, such as 7 MPa or less, such as 6.5 MPa or less, such as 6 MPa or less, such as 5.5 MPa or less, such as 5 MPa or less, such as 4.5 MPa or less, such as 4 MPa or less, such as 3.5 MPa or less, such as 3 MPa or less, such as 2.8 or less, such as 2.5 MPa or less, such as 2.2 MPa or less, such as 2 MPa or less, such as 1.8 MPa or less, such as 1.5 MPa or less. The ultimate tensile strength may be determined in accordance with ASTM D412-16(2021) at a temperature of 23° C. (Die C, across flow). In one embodiment, the aforementioned ultimate tensile strength may be for an unaged sample.

The thermoplastic vulcanizate and/or corresponding composition may also exhibit a desired ultimate elongation. For instance, the ultimate elongation may be 100% or more, such as 125% or more, such as 150% or more, such as 175% or more, such as 200% or more, such as 220% or more, such as 240% or more, such as 260% or more, such as 280% or more, such as 300% or more, such as 350% or more, such as 400% or more, such as 500% or more. The ultimate elongation may be 1000% or less, such as 900% or less, such as 800% or less, such as 700% or less, such as 600% or less, such as 500% or less, such as 450% or less, such as 400% or less, such as 380% or less, such as 360% or less, such as 340% or less, such as 320% or less, such as 300% or less, such as 280% or less, such as 260% or less, such as 240% or less, such as 220% or less, such as 200% or less. The ultimate elongation may be determined in accordance with ASTM D412-16(2021) at a temperature of 23° C. (Die C, across flow). In one embodiment, the aforementioned ultimate elongation may be for an unaged sample.

The thermoplastic vulcanizate and/or corresponding composition may also be characterized by an advantageously low compression set. For instance, the compression set may be 85% or less, such as 80% or less, such as 70% or less, such as 65% or less, such as 60% or less, such as 55% or less, such as 50% or less, such as 45% or less, such as 40% or less, such as 35% or less, such as 30% or less, such as 25% or less, such as 20% or less, such as 15% or less. The compression set may be 5% or more, such as 8% or more, such as 10% or more, such as 13% or more, such as 15% or more, such as 18% or more, such as 20% or more, such as 25% or more, such as 30% or more, such as 35% or more, such as 40% or more, such as 50% or more, such as 60% or more, such as 70% or more. The compression set may be determined in accordance with ASTM D395B-18 (Type 1 Specimen, 70° C.; 25% at 22 hours or 50% at 96 hours). In this regard, such compression set may be realized at least at one, such as at least at two of the conditions.

The thermoplastic vulcanizate and/or corresponding composition may also have a certain tension set. The thermoplastic vulcanizate can have a tension set from about 1%, about 2%, about 3%, about 4%, or about 5% to about 5%, about 6%, about 7%, about 8%, about 9%, about 10%, about 11%, about 12%, about 13%, about 14%, about 15%, about 16%, about 17%, about 18%. The tension set may be about 30% or less, such as 25% or less, such as 22% or less, such as 20% or less, such as 18% or less, such as 16% or less, such as 14% or less, such as 12% or less, such as 10% or less. The tension set may be measured according to ISO 412 (50%, 70° C., 22 hours).

The thermoplastic vulcanizate and/or corresponding composition may also be characterized by an LCR viscosity, as determined according to ASTM D3835-16 at 204° C. using a die with a 1 mm diameter, 30 mm length, 180° entry angle, and at a shear rate of 1200 s⁻¹ with a CEAST SmartRheo apparatus. For instance, the LCR viscosity at ASTM D638-14 1200s−1 may be 30 Pa·s or more, such as 32 Pa·s or more, such as 34 Pa·s or more, such as 36 Pa·s or more, such as 38 Pa·s or more, such as 40 Pa·s or more, such as 42 Pa·s or more, such as 44 Pa·s or more, such as 46 Pa·s or more, such as 48 Pa·s or more, such as 50 Pa·s or more, such as 52 Pa·s or more, such as 56 Pa·s or more, such as 60 Pa·s or more. The LCR viscosity at 1200 s−1 may be 100 Pa·s or less, such as 90 Pa·s or less, such as 80 Pa·s or less, such as 70 Pa·s or less, such as 60 Pa·s or less, such as 56 Pa·s or less, such as 54 Pa·s or less, such as 52 Pa·s or less, such as 50 Pa·s or less, such as 48 Pa·s or less, such as 46 Pa·s or less, such as 44 Pa·s or less, such as 40 Pa·s or less, such as 38 Pa·s or less.

In addition to the above properties, the thermoplastic vulcanizate and/or corresponding composition may exhibit a desirable color. In particular, the thermoplastic vulcanizate and/or corresponding composition may exhibit particular values for L* and/or a* in accordance with CIELAB (CIE 1976 color space) wherein for a given illumination condition, L* is a value for lightness and a* is a value for a color-opponent dimension. In this regard, L* may range from 70 to 95, such as 75 to 95, such as 75 to 90, such as 75 to 88, such as 78 to 88, such as 80 to 88, such as 82 to 88, such as 84 to 88. In addition, a* may range from −10 to 10, such as from −10 to 5, such as from −10 to 0, such as from −5 to 0, such as from −3 to 0, such as from −1 to 0, such as from −1 to −0.5. The values may be determined in accordance with ASTM D2244-21 with a HunterLab Labscan XE Spectrophotometer.

### II. Foaming

As indicated above, the thermoplastic vulcanizate and corresponding formulation and composition may have certain properties allowing it to be foamed. In particular, a foaming agent may be utilized to foam the thermoplastic vulcanizate and corresponding formulation and composition and form a foamed thermoplastic vulcanizate and corresponding composition.

In this regard, a physical foaming agent and/or a chemical foaming agent may be utilized. In one embodiment, a physical foaming agent may be utilized. In another embodiment, a chemical foaming agent may be utilized. Furthermore, in one embodiment, one foaming agent may be utilized. In other embodiments, the foaming agent may include a mixture of foaming agents. For instance, more than one foaming agent, such as two or three foaming agents, may be utilized in the thermoplastic vulcanizate and corresponding formulation and/or composition.

In one embodiment, a chemical foaming agent may be utilized. Without intending to be limited, chemical foaming agents decompose at elevated temperatures to form gases or vapors to blow or foam the thermoplastic vulcanizate and corresponding formulation and composition into foam form. The agent preferably takes a solid form, so it is conveniently dry-blended.

Chemical foaming agents include, but are not limited to, organic foaming agents, such as 4,4′-oxybis benzene sulfonyl hydrazide; azodicarbonamide; azobisformamide; azobisisobutyronitrile; diazoaminobenzene; N,N-dimethyl-N,N-dinitroso terephthalamide; N,N-dinitrosopentamethylene-tetramine; benzenesulfonyl-hydrazide; benzene-1,3-disulfonyl hydrazide; diphenylsulfon-3-3, disulfonyl hydrazide; p-toluene sulfonyl semicarbizide; barium azodicarboxylate; butylamine nitrile; nitroureas; trihydrazino triazine; phenyl-methyl-uranthan; p-sulfonhydrazide; peroxides; and inorganic foaming agents such as ammonium bicarbonate and sodium bicarbonate.

In one embodiment, a physical foaming agent may be utilized. The physical foaming agent may include water, hydrocarbons such as pentane, propane and butane, fluorocarbons, hydrofluorocarbons, chlorofluorocarbons, hydrochlorofluorocarbons, nitrogen, and supercritical fluids such as carbon dioxide.

In one embodiment, the physical foaming agent may include a thermo-expandable sphere. A thermo-expandable microsphere is broadly defined as a microsphere comprising a polymer shell and a propellant encapsulated therein. In general, a polymer shell is any shell-like structure made from a polymer. It can be hollow, filled, or partially filled, such as with a propellant. The propellant can be any liquid having a boiling temperature not higher than the softening temperature of the thermoplastic polymer shell. Expansion of the thermoplastic microspheres is typically physical by nature. It is believed that as the propellant is heated up, the propellant expands, increasing the intrinsic pressure; at the same time the shell softens, thus causing the microspheres' expansion, normally from about 2 to about 8 times their diameter, or about 30 to about 80 times volume, and the thickness of polymer shell may decrease to 0.1 μm or even thinner. Factors that may affect the expandability of the microspheres include volatility of the encapsulated propellant, gas permeability, and viscoelasticity of the polymer shell.

Various monomers are suitable for preparation of the polymer shell and may comprise acrylonitrile, methacrylonitrile, α-haloacrylonitrile, α-ethoxyacrylonitrile, fumarc nitrile, acrylic esters or any combinations thereof. In some particular embodiments, the monomer is made from polyacrylonitrile. The polymer shell may have a softening temperature (i.e., the glass transition temperature (Tg) ranging from about 80° C. to about 200° C.).

The liquids suitable for preparation of the propellant of the thermo-expandable microsphere usually have a boiling point lower than the softening temperature of the polymer shell at atmosphere pressure. Suitable liquids include, but are not limited to, hydrocarbon liquids (such as isobutane, 2,4-dimethylbutane, 2-methylpentane, 3-methylpentane, n-hexane, cyclohexane, heptane, isooctane, or any combinations thereof).

When a thermo-expandable microsphere is heated up, it starts to expand at a certain temperature. The temperature at which the expansion starts is called the initiation temperature, or Tᵢₙᵢₜᵢₐₜᵢₒₙ, while the temperature at which the maximum expansion is reached is called Tₘₐₓ. The Tᵢₙᵢₜᵢₐₜᵢₒₙ and Tₘₐₓ can be measured by thermo-mechanical analysis (TMA) of thermo expansion property. Suitable thermo-expandable microspheres may have a Tᵢₙᵢₜᵢₐₜᵢₒₙ of at least about 100° C., preferably at least about 110° C. or 120° C., more preferably at least 130° C., or even at least 140° C., and a Tₘₐₓ of less than 300° C., such as less than any one of 260° C., 240° C., 220° C., or 210° C.

Thermo-expandable microspheres suitable for foamed TPV compositions of some embodiments may have various pre-expansion average particle sizes. In some embodiments, the average particle size may range from about 1 μm to about 500 μm, preferably from about 2 μm to about 300 μm, such as from about 4 μm to about 100 μm, 5 to 50 μm, or 10 to 45 μm, with ranges from any of the foregoing low ends to any of the foregoing high ends also contemplated in various embodiments. The average particle size of the expandable microsphere, after expansion, is preferably not less than about 50 um, preferably no less than about 80 μm, more preferably no less than about 100 μm, and most preferably not less than about 120 μm.

Thermo-expandable microspheres can be produced by any suitable method. For instance, suitable production methods may include a step of polymerizing the monomers in an aqueous suspension in the presence of a propellant, and are known as described in, e.g., U.S. Pat. No. 3,615,972, WIPO Publication Nos. WO 99/46320, and WO 99/43758, the contents of which are hereby incorporated by reference.

Due to the small size of the microspheres, it may be preferable to utilize the microspheres in masterbatch form. The carrier polymer for the masterbatch is preferably a thermoplastic resin or propylene-based elastomer. For instance, suitable carrier resins may include polyethylene, polypropylene, ethylene/methyl-methacrylate copolymers, propylene-based elastomers, propylene-ethylene or other propylene-α-olefin copolymers (including impact copolymers and random copolymers), ethylene vinyl acetate (EVA), and other thermoplastic resins suitable for making masterbatches of small particulate matter.

Thermo-expandable microspheres may provide particular advantages in forming foamed thermoplastic vulcanizate compositions in accordance with some embodiments. Thermo-expandable microspheres do not behave like conventional chemical foaming agents when creating low-density TPV materials using such microspheres. In particular, a gas bubble is not formed (as is the case with typical chemical foaming). Instead, each thermo-expandable microsphere behaves somewhat akin to popcorn: in the unheated state, these materials are dense solids (e.g., specific gravity about 0.85 g/cc), but upon exposure to sufficient heat (precise temperature depending upon the type of microsphere and/or microsphere masterbatch used), the microsphere pops, forming a small, very low-density spherical particle of about 0.02 g/cc specific gravity. In this way, microsphere technology is more akin to forming a physical blend of high and low density components, than a conventional foam. Furthermore, the thus-described formation of low-density spherical particles creates an advantageous network of closed low-density cells that are isolated and further that do not create openings extending from the surface into the interior of the article, leading to superior sealing against air/water ingress and the like. Thus, although the shorthand “foam” and “foaming” may be used in the present application, when applied to such “popped” thermo-expandable microspheres (e.g., those having been exposed to sufficient heat to convert the micro-spheres to their low-density state), such terms could just as well be taken to mean a physical blend of high-density and low-density particles.

The foaming agent can be employed in an amount of 10 wt. % or less, such as 8 wt. % or less, such as 6 wt. % or less, such as 5 wt. % or less, such as 4 wt. % or less, such as 3 wt. % or less, such as 2.5 wt. % or less, such as 2 wt. % or less, such as 1.5 wt. % or less based on the weight of the thermoplastic vulcanizate composition. The foaming agent may be used in an amount of about 0.1 wt. or more, such as 0.2 wt. or more, such as 0.3 wt. or more, such as 0.4 wt. or more, such as 0.5 wt. or more, such as 0.8 wt. or more, such as 1 wt. or more based on the weight of the thermoplastic vulcanizate composition. In one embodiment, such aforementioned weight percentages may be based on the weight of the thermoplastic resin and the rubber. In another embodiment, such aforementioned weight percentages may be based on the weight of the thermoplastic resin, the rubber, and the propylene-based elastomer.

The foamed thermoplastic vulcanizate composition may be prepared using means generally known in the art. For instance, a formulation or composition including a foaming agent may first be formed. In one embodiment, it may be preferred to first obtain a foamable thermoplastic vulcanizate composition that does not include a foaming agent and then to combine the composition with a foaming agent. Such components may be blended, such as dry blended, using the techniques mentioned above. As examples, they may be blended in a tumbler, continuous mixer, static mixer, batch mixer, extruder, or a combination thereof that is sufficient to achieve an adequate dispersion of the components.

One general method may include (i) heating the thermoplastic vulcanizate composition or formulation to a temperature above the melting point of the thermoplastic resin, propylene-based elastomer, or both, (ii) adding a foaming agent, and (iii) releasing the composition to atmospheric temperature and pressure. In certain embodiments, the composition or formulation may already include the foaming agent such that the method may simply need the heating and releasing steps above. Depending on the type of foaming agent employed, the foaming agent may be added to the thermoplastic vulcanizate prior to heating the thermoplastic vulcanizate in the foaming process or it may be added to the thermoplastic vulcanizate while it is in its molten state. Also, high pressure may be typically required to prevent the foaming agent from prematurely expanding prior to releasing the thermoplastic vulcanizate to atmospheric temperature and pressure. Where a chemical blowing agent is employed, the step of heating should heat the thermoplastic vulcanizate and foaming agent high enough to trigger the chemical decomposition of the foaming agent.

In this regard, the formulation or composition may be extruded to form the foamed material. The foamed material may be made or formed by any useful discrete molding or continuous extrusion means for forming and shaping polyolefins known in the art, including: sheet extrusion, profile extrusion or co-extrusion, compression molding, injection molding, co-injection molding, gas-assisted injection molding, transfer molding, foam molding, transfer molding, vacuum forming, lamination, calendaring, or other forms of processing such as described in, for example, “Rubber Technology,” by Maurice Norton (Van Nostrand Reinhold-New York), or combinations thereof. Among these, extrusion including co-extrusion is particularly suitable for forming the foamed material of the present invention.

The foamed thermoplastic vulcanizate composition may have a particular density. The density may be 0.3 g/cm³ or more, such as 0.35 g/cm³ or more, such as 0.4 g/cm³ or more, such as 0.43 g/cm³ or more, such as 0.45 g/cm³ or more, such as 0.58 g/cm³ or more, such as 0.5 g/cm³ or more, such as 0.53 g/cm³ or more, such as 0.55 g/cm³ or more, such as 0.58 g/cm³ or more, such as 0.6 g/cm³ or more, such as 0.62 g/cm³ or more, such as 0.65 g/cm³ or more, such as 0.68 g/cm³ or more, such as 0.7 g/cm³ or more. The density may be 1.0 g/cm³ or less, such as 0.9 g/cm³ or less, such 0.8 g/cm³ or less, 0.77 g/cm³ or less, such as 0.75 g/cm³ or less, such as 0.73 g/cm³ or less, such as such as 0.7 g/cm³ or less, such as 0.68 g/cm³ or less, such as 0.65 g/cm³ or less, such as 0.63 g/cm³ or less, such as 0.6 g/cm³ or less, such as 0.58 g/cm³ or less.

In addition, the foamed thermoplastic vulcanizate composition may have a relatively low hardness. For instance, the Shore A hardness may be 45 or less, such as 43 or less, such as 40 or less, such as 38 or less, such as 35 or less, such as 33 or less, such as 30 or less, such as 28 or less, such as 25 or less, such as 23 or less. The Shore A hardness may be 15 or more, such as 18 or more, such as 20 or more, such as 22 or more, such as 25 or more, such as 27 or more. Such hardness may allow for the thermoplastic vulcanizate and/or composition and/or resulting molded part/article to provide the compliance necessary to effectively function for a desired application. In one embodiment, the aforementioned Shore A hardness may be for an unaged sample. The Shore A hardness may be determined in accordance with ASTM 2240-15(2021) (15 seconds).

### III. Formation of Molded Parts

Once formed, the thermoplastic vulcanizate and composition, such as the foamed thermoplastic vulcanizate and composition, may be shaped into the form of a molded part using any of a variety of techniques as is known in the art. For instance, the thermoplastic vulcanizate and composition, such as the foamed thermoplastic vulcanizate and composition, can advantageously be fabricated by employing typical molding processes, such as injection molding, extrusion molding, compression molding, blow molding, rotational molding, overmolding, etc. In general, as indicated herein, these processes include heating the thermoplastic vulcanizate and composition with the foaming agent to a temperature that is equal to or in excess of the melt temperature of the thermoplastic resin to form a pre-form for a mold cavity to then form the molded part, cooling the molded part to a temperature at or below the crystallization temperature of the thermoplastic vulcanizate and/or corresponding composition, and releasing the molded part from a mold. The mold cavity defines the shape of the molded part. The molded part is cooled within the mold at a temperature at or below the crystallization temperature of the thermoplastic vulcanizate and/or corresponding composition and the molded part can subsequently be released from the mold.

The thermoplastic vulcanizate and composition, such as the foamed thermoplastic vulcanizate and composition, may also be shaped using extrusion molding to form the molded part. In this regard, the thermoplastic vulcanizate and composition along with the foaming agent may be extruded as described herein. Upon exiting the extruder, the thermoplastic vulcanizate and composition may be foamed and formed or shaped to form the molded part. Such molded part may be formed by using a particular die to shape the thermoplastic vulcanizate and composition, such as the foamed thermoplastic vulcanizate and composition, as it exits the extruder. Such shaping/forming process, such as the extrusion process, may be an automated or robotic process. In this regard, the method of forming a molded part is not necessarily limited.

The thermoplastic vulcanizate and corresponding composition, in particular once foamed, as disclosed herein may be utilized in a variety of applications. For instance, the applications may be for the automotive industry, oilfield industry, consumer goods industry, electronics industry, electrical industry, medical industry, etc. In particular, in one embodiment, the molded part may be for an automotive part. Particular molded parts may include, but are not limited to, seals, gaskets, weatherstrips, ducts, belts, moldings, automotive boots and bellows (e.g., for steering and suspension), tubing, hoses, splines, glass run channels (all or any portion thereof, such as foot or base portions), and the like articles. Other molded parts may include, for example, car parts or components such as instrument panel skins, door skins, expanded backings for instrument panel skins and door skins, door trims, pillars, console boxes, steering wheels, shift levers, air boxes, dash panels, replaceable seat cushions, differential gear garnishes, curl top garnishes, ceiling materials, weather strip sponges, trunk room linings, engine room linings, bumpers, fenders, hood surface layers, side shields, and cushions; motorcycle parts and components such as handlebar grips, helmet linings, seats, and surface layers for racing suits; parts and products for office automation (OA) equipment, such as mice, keyboards, and housings for OA equipment, mouse pads, desk mats; headphones; electronic calculators; telephone handsets; housings for PHS (personal handy-phone system), other mobile phones and the like; miscellaneous goods such as system pocketbooks, wallets, notebooks, document holders, bags, toilet seats, pencils, ballpoint pens, fountain pens, carpets, handles for kitchen knives, and grips for hedge shears or trimmers; footwear such as sandals, slippers, shoe soles and sandals; electric parts such as wire coverings, connectors, caps, and plugs; construction materials such as cut-off boards, sealing sponges, and noise barrier walls; equipment for leisure time amusement, such as grips for golf clubs, grips for baseball bats, grips for tennis rackets, fins for skin diving, and swimming goggles; miscellaneous industrial items such as gaskets, waterproof sheets, garden hoses, drive belts, and industrial packings.

### Test Methods

The following test methods may be employed to determine the properties referenced herein.

Melting Temperature, Glass Transition Temperature, Heat of Fusion: The melting temperature (“Tm”), glass transition temperature (“Tg”), and the heat of fusion (“Hf”) may be determined by differential scanning calorimetry (“DSC”) as is known in the art using commercially available equipment such as a TA Instruments Model Q100. Typically, 6 to 10 mg of the sample, that has been stored at room temperature (about 23° C.) for at least 48 hours, is sealed in an aluminum pan and loaded into the instrument at room temperature (about 23° C.). The sample is equilibrated at 25° C. and then it is cooled at a cooling rate of 10° C./min to −80° C. The sample is held at −80° C. for 5 min and then heated at a heating rate of 10° C./min to 25° C. The glass transition temperature is measured from this heating cycle (“first heat”). For samples displaying multiple peaks, the melting point (or melting temperature) is defined to be the peak melting temperature associated with the largest endothermic calorimetric response in that range of temperatures from the DSC melting trace. The T_{g} was measured by again heating the sample from −80° C. to 80° C. at a rate of 20° C./min (“second heat”). The glass transition temperature reported is the midpoint of step change when heated during the second heating cycle. Areas under the DSC curve are used to determine the heat of transition (heat of fusion, Hf, upon melting or heat of crystallization, Hc, upon crystallization, if the Hf value from the melting is different from the Hc value obtained for the heat of crystallization, then the value from the melting (Tm) shall be used), which can be used to calculate the degree of crystallinity (also called the percent crystallinity). The percent crystallinity (X %) is calculated using the formula: [area under the curve (in J/g)/H° (in J/g)]*100, where H° is the heat of fusion for the homopolymer of the major monomer component. These values for H° are to be obtained from the Polymer Handbook, Fourth Edition, published by John Wiley and Sons, New York 1999, except that a value of 290 J/g is used as the equilibrium heat of fusion (H°) for 100% crystalline polyethylene, a value of 140 J/g is used as the equilibrium heat of fusion (H°) for 100% crystalline polybutene, and a value of 207 J/g (H°) is used as the heat of fusion for a 100% crystalline polypropylene.

### EXAMPLES

### Example 1

The components identified in the table provided below were utilized in forming the thermoplastic vulcanizate and corresponding composition. The propylene-based elastomer was introduced pre-dynamic vulcanization. The components were melt blended and dynamically cured to provide a thermoplastic vulcanizate including an at least partially cured rubber. The melt blending and dynamic vulcanization was conducted using a twin-screw extruder set at a temperature of from 90° C. through 210° C. The speed was set to about 300 rpm. The resulting thermoplastic vulcanizate and corresponding composition were tested for various properties.

The thermoplastic vulcanizate and corresponding composition were also foamed using a masterbatch of unexpanded thermoplastic microspheres in an ethylene vinyl acetate carrier. The microspheres had a particle size of around 120 μm. The foaming density of the foamed thermoplastic vulcanizate was determined.

| | Comparative | Comparative | Sample | Sample | Sample | Sample | Sample | Sample | Sample |
|---|---|---|---|---|---|---|---|---|---|
| | Sample 1 | Sample 2 | 1 | 2 | 3 | 4 | 5 | 6 | 7 |
| Formulation (phr) | | | | | | | | | |
| Ethylene- | 100 | 100 | 100 | 100 | 100 | 100 | — | — | — |
| propylene-vinyl- | | | | | | | | | |
| norbornene | | | | | | | | | |
| Ethylene- | — | — | — | — | — | — | 100 | 100 | 100 |
| propylene- | | | | | | | | | |
| ethylidene- | | | | | | | | | |
| norbornene | | | | | | | | | |
| Kaolin clay | 30 | 30 | 30 | 30 | 30 | 30 | 32 | 32 | 32 |
| Zinc oxide | 2.0 | 2.0 | 2.0 | 2.0 | 2.0 | 2.0 | 2.0 | 2.0 | 2.0 |
| Stannous chloride | — | — | — | — | — | — | 1.26 | 1.26 | 1.26 |
| (45 wt. %) | | | | | | | | | |
| masterbatch in | | | | | | | | | |
| polypropylene | | | | | | | | | |
| Polypropylene | 31.0 | 15.5 | 15.5 | 12.4 | 7.8 | 15.5 | — | — | — |
| homopolymer | | | | | | | | | |
| (3.5 g/10 min | | | | | | | | | |
| MFR at | | | | | | | | | |
| 230° C./2.16 kg) | | | | | | | | | |
| Polypropylene | — | — | — | — | — | — | 9.25 | 7.75 | — |
| homopolymer | | | | | | | | | |
| (0.83 g/10 min | | | | | | | | | |
| MFR at | | | | | | | | | |
| 230° C./2.16 kg) | | | | | | | | | |
| Polypropylene | — | — | — | — | — | — | — | — | 5.63 |
| homopolymer | | | | | | | | | |
| (0.8 g/10 min | | | | | | | | | |
| MFR at | | | | | | | | | |
| 230° C./2.16 kg) | | | | | | | | | |
| Reaction product | — | — | — | — | — | — | — | — | 2.12 |
| of UHMW | | | | | | | | | |
| siloxane with | | | | | | | | | |
| polypropylene | | | | | | | | | |
| Propylene-olefinic | — | — | 15.5 | 18.6 | 23.3 | — | 27.75 | 23.35 | 23.35 |
| terpolymer | | | | | | | | | |
| elastomer 1 (C₂; | | | | | | | | | |
| C₃; C₄) | | | | | | | | | |
| Propylene-olefinic | — | — | — | — | — | 15.5 | — | — | — |
| terpolymer | | | | | | | | | |
| elastomer 2 (C₂; | | | | | | | | | |
| C₃; C₄) | | | | | | | | | |
| Propylene-olefinic | — | 15.5 | — | — | — | — | — | — | — |
| copolymer/ | | | | | | | | | |
| elastomer | | | | | | | | | |
| (C₂-21.1 mol %; | | | | | | | | | |
| C₃-78.9 mol %) | | | | | | | | | |
| Carbon black (41 | — | — | — | — | — | — | 5.0 | 5.0 | 5.0 |
| wt. %) | | | | | | | | | |
| masterbatch in | | | | | | | | | |
| polypropylene | | | | | | | | | |
| Phenolic resin in | — | — | — | — | — | — | 11.7 | 11.7 | 11.7 |
| oil | | | | | | | | | |
| Silicon-hydride | 2.0 | 2.0 | 2.0 | 2.0 | 2.0 | 2.0 | — | — | — |
| functional | | | | | | | | | |
| polysiloxane | | | | | | | | | |
| Platinum catalyst | 0.005952 | 0.005952 | 0.005952 | 0.005952 | 0.005952 | 0.005952 | — | — | — |
| slurry in oil | | | | | | | | | |
| Paraffinic oil | 239.95 | 239.95 | 239.95 | 239.95 | 239.95 | 239.95 | 215.00 | 230.00 | 230.00 |
| Calcium stearate | 0.97 | 0.97 | 0.97 | 0.97 | 0.97 | 0.97 | — | — | — |
| Sterically | 0.48 | 0.48 | 0.48 | 0.48 | 0.48 | 0.48 | — | — | — |
| hindered phenol | | | | | | | | | |
| antioxidant | | | | | | | | | |
| Total (phr) | 406.41 | 406.41 | 406.41 | 406.41 | 406.41 | 406.41 | 403.93 | 413.03 | 413.03 |
| Wt ratio | — | ~50:50 | ~50:50 | ~60:40 | ~75:25 | ~50:50 | ~75:25 | ~75:25 | ~75:25 |
| (Propylene- | | | | | | | | | |
| olefinic | | | | | | | | | |
| copolymer/ | | | | | | | | | |
| elastomer:poly- | | | | | | | | | |
| propylene | | | | | | | | | |
| homopolymer) | | | | | | | | | |
| Specific Gravity | 0.91 | 0.91 | 0.91 | 0.91 | 0.91 | 0.91 | 0.92 | 0.91 | 0.91 |
| (22.7° C.) (g/cm³) | | | | | | | | | |
| LCR @1200 s⁻¹ | 34.7 | 43.9 | 38.9 | 39.2 | 39.8 | 40.1 | 49.8 | 54.9 | 41.0 |
| (204° C.) (Pa · s) | | | | | | | | | |
| Shore A | 38.9 | 22.04 | 28.7 | 25.0 | 21.7 | 23.82 | 28.9 | 25.4 | 27 |
| Hardness | | | | | | | | | |
| Color - L* | 84.47 | — | 86.14 | 84.73 | 84.68 | — | — | — | — |
| Color - a* | −0.69 | — | −0.77 | −0.69 | −0.71 | — | — | — | — |
| Tensile | | | | | | | | | |
| Properties | | | | | | | | | |
| Ultimate Tensile | 2.45 | 1.8 | 2.36 | 2.25 | 2.0 | 2.2 | 2.3 | 1.9 | 1.7 |
| Strength (MPa) | | | | | | | | | |
| Ultimate | 279 | 263 | 269 | 316 | 296 | 273 | 296 | 274 | 240 |
| Elongation (%) | | | | | | | | | |
| Modulus at 100% | 1.14 | 0.67 | 0.87 | 0.70 | 0.48 | 0.79 | 0.79 | 0.69 | 0.70 |
| Elongation (MPa) | | | | | | | | | |
| Compression Set | 22.37 | 14.9688 | 27.47 | 25.31 | 23.9669 | 22.6263 | 20.4918 | 19.3277 | — |
| (%) (25%, 70° C., | | | | | | | | | |
| 22 h) | | | | | | | | | |
| Compression Set | 27.20 | — | 30.50 | 34.80 | — | — | 32.20 | 30.60 | — |
| (%) | | | | | | | | | |
| (50%, 70° C., 22 h) | | | | | | | | | |
| Tension Set (%) | 16.8 | 16.7 | 18.5 | 17.8 | 18.0 | 15.3 | 10.8 | 16.0 | — |
| (50%, 70° C., 22 h) | | | | | | | | | |
| Foamed TPV | | | | | | | | | |
| Foaming agent | 2.5 | 2.5 | 2.5 | 2.5 | 2.5 | 2.5 | 2.5 | 2.5 | 2.5 |
| (65 wt. %) | | | | | | | | | |
| masterbatch | | | | | | | | | |
| Foam Density | 0.5381 | 0.5784 | 0.5800 | 0.6152 | 0.6142 | 0.5580 | 0.6102 | 0.6457 | — |
| (Omega die) | | | | | | | | | |
| (g/cm³) | | | | | | | | | |
| Formulation (wt. %) | | | | | | | | | |
| Ethylene- | 24.61 | 24.61 | 24.61 | 24.61 | 24.61 | 24.61 | — | — | — |
| propylene-vinyl- | | | | | | | | | |
| norbornene | | | | | | | | | |
| Ethylene- | — | — | — | — | — | — | 24.76 | 24.21 | 24.21 |
| propylene- | | | | | | | | | |
| ethylidene- | | | | | | | | | |
| norbornene | | | | | | | | | |
| Kaolin clay | 7.38 | 7.38 | 7.38 | 7.38 | 7.38 | 7.38 | 7.92 | 7.75 | 7.75 |
| Zinc oxide | 0.49 | 0.49 | 0.49 | 0.49 | 0.49 | 0.49 | 0.50 | 0.48 | 0.48 |
| Stannous chloride | — | — | — | — | — | — | 0.31 | 0.31 | 0.31 |
| (45 wt. %) | | | | | | | | | |
| masterbatch in | | | | | | | | | |
| polypropylene | | | | | | | | | |
| Polypropylene | 7.63 | 3.81 | 3.81 | 3.05 | 1.91 | 3.81 | — | — | — |
| homopolymer | | | | | | | | | |
| (3.5 g/10 min MFR | | | | | | | | | |
| at 230° C./2.16 kg) | | | | | | | | | |
| Polypropylene | — | — | — | — | — | — | 2.29 | 1.88 | — |
| homopolymer | | | | | | | | | |
| (0.83 g/10 min | | | | | | | | | |
| MFR at 230° C./2.16 | | | | | | | | | |
| kg) | | | | | | | | | |
| Polypropylene | — | — | — | — | — | — | — | — | 1.36 |
| homopolymer | | | | | | | | | |
| (0.8 g/10 min MFR | | | | | | | | | |
| at 230° C./2.16 kg) | | | | | | | | | |
| Reaction product of | — | — | — | — | — | — | — | — | 0.51 |
| UHMW siloxane | | | | | | | | | |
| with polypropylene | | | | | | | | | |
| Propylene-olefinic | — | — | 3.81 | 4.58 | 5.72 | — | 6.87 | 5.65 | 5.65 |
| copolymer/ | | | | | | | | | |
| elastomer | | | | | | | | | |
| (C₂-25.1 mol %; C₃- | | | | | | | | | |
| 62.6 mol %; C₄-12.3 | | | | | | | | | |
| mol %) | | | | | | | | | |
| Propylene-olefinic | — | — | — | — | — | 3.81 | — | — | — |
| copolymer/ | | | | | | | | | |
| elastomer | | | | | | | | | |
| (C₂-28.5 mol %; C₃- | | | | | | | | | |
| 67.9 mol %; C₄-3.6 | | | | | | | | | |
| mol %) | | | | | | | | | |
| Propylene-olefinic | — | 3.81 | — | — | — | — | — | — | — |
| copolymer/ | | | | | | | | | |
| elastomer | | | | | | | | | |
| (C₂-21.1 mol %; C₃- | | | | | | | | | |
| 78.9 mol %) | | | | | | | | | |
| Carbon black (41 | — | — | — | — | — | — | 1.24 | 1.21 | 1.21 |
| wt. %) masterbatch | | | | | | | | | |
| in polypropylene | | | | | | | | | |
| Phenolic resin in oil | — | — | — | — | — | — | 2.89 | 2.82 | 2.82 |
| Silicon-hydride | 0.49 | 0.49 | 0.49 | 0.49 | 0.49 | 0.49 | — | — | — |
| functional | | | | | | | | | |
| polysiloxane | | | | | | | | | |
| Platinum catalyst | 0.0015 | 0.0015 | 0.0015 | 0.0015 | 0.0015 | 0.0015 | — | — | — |
| slurry in oil | | | | | | | | | |
| Paraffinic oil | 59.04 | 59.04 | 59.04 | 59.04 | 59.04 | 59.04 | 53.23 | 55.69 | 55.69 |
| Calcium stearate | 0.24 | 0.24 | 0.24 | 0.24 | 0.24 | 0.24 | — | — | — |
| Sterically hindered | 0.12 | 0.12 | 0.12 | 0.12 | 0.12 | 0.12 | — | — | — |
| phenol antioxidant | | | | | | | | | |
| Total (wt. %) | 100.00 | 100.00 | 100.00 | 100.00 | 100.00 | 100.00 | 100.00 | 100.00 | 100.00 |

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A thermoplastic vulcanizate composition comprising:
a thermoplastic vulcanizate comprising a thermoplastic resin, an at least partially cured rubber, and a propylene-based elastomer formed from at least three alpha-olefins;
wherein the thermoplastic vulcanizate composition exhibits a Shore A hardness of 45 or less in accordance with ASTM 2240-15(2021) (15 seconds; unaged).

2. The thermoplastic vulcanizate composition of claim 1, wherein the thermoplastic resin comprises a polypropylene.

3. The thermoplastic vulcanizate composition of claim 1, wherein the thermoplastic resin is present in an amount of 0.5 wt. % or more to 25 wt. % or less based on the weight of the thermoplastic vulcanizate composition.

4. The thermoplastic vulcanizate composition of claim 1, wherein the rubber comprises an ethylene/propylene/non-conjugated diene copolymer rubber (EPDM).

5. The thermoplastic vulcanizate composition of claim 1, wherein the rubber is fully vulcanized.

6. The thermoplastic vulcanizate composition of claim 1, wherein the at least partially cured rubber is present in an amount of 2 wt. % or more to 50 wt. % or less based on the weight of the thermoplastic vulcanizate composition.

7. The thermoplastic vulcanizate composition of claim 1, wherein the propylene-based elastomer is formed from propylene and ethylene, wherein propylene constitutes 60 mol % or more of the propylene-based elastomer.

8. The thermoplastic vulcanizate composition of claim 7, wherein the propylene-based elastomer further is formed from a C₄-C₁₀ alpha olefin.

9. The thermoplastic vulcanizate composition of claim 1, wherein the propylene-based elastomer is present in an amount of 0.5 wt. % or more to 15 wt. % or less based on the weight of the thermoplastic vulcanizate composition.

10. The thermoplastic vulcanizate composition of claim 1, wherein the thermoplastic vulcanizate composition exhibits a Shore A hardness of 35 or less in accordance with ASTM 2240-15(2021) (15 seconds; unaged).

11. The thermoplastic vulcanizate composition of claim 1, wherein the thermoplastic vulcanizate composition exhibits a Shore A hardness of 30 or less in accordance with ASTM 2240-15(2021) (15 seconds; unaged).

12. The thermoplastic vulcanizate composition of claim 1, wherein the thermoplastic vulcanizate composition exhibits an ultimate tensile strength of from 0.5 MPa to 5 MPa as determined in accordance with ASTM D412-16(2021) (unaged).

13. The thermoplastic vulcanizate composition of claim 1, wherein the thermoplastic vulcanizate composition exhibits an ultimate elongation of from 100% to 500% as determined in accordance with ASTM D412-16(2021) (unaged).

14. The thermoplastic vulcanizate composition of claim 1, wherein the thermoplastic vulcanizate composition exhibits a modulus at 100% elongation of 0.1 MPa or more to 1 MPa or less as determined in accordance with ASTM D412-16(2021) (Die C, across flow).

15. The thermoplastic vulcanizate composition of claim 1, further comprising a foaming agent.

16. The thermoplastic vulcanizate composition of claim 15, wherein the foaming agent comprises a thermo-expandable microsphere comprising a polymer shell and a propellant encapsulated in the polymer shell.

17. A foamed thermoplastic vulcanizate composition formed from the thermoplastic vulcanizate composition of claim 15.

18. A foamed thermoplastic vulcanizate composition comprising the thermoplastic vulcanizate composition of claim 1 and an expanded thermo-expandable microsphere.

19. A molded part formed from the foamed thermoplastic vulcanizate composition of claim 17.

20. The molded part of claim 19, wherein the molded part is an automotive molded part.
